(19) United States
(12) Patent Application Publication
(10) Pub. No.: US 2014/0222403 A1
(43) Pub. Date: Aug. 7, 2014

(54) GEOLOGIC MODEL VIA IMPLICIT FUNCTION

(71) Applicant: Schlumberger Technology Corporation, Sugar Land, TX (US)

(72) Inventors: Francois Lepage, Montpellier (FR); Laurent Arnaud Souche, Montpellier (FR)

(73) Assignee: Schlumberger Technology Corporation, Sugar Land, TX (US)

(21) Appl. No.: 14/173,956

(22) Filed: Feb. 6, 2014

(30) Foreign Application Priority Data
Feb. 7, 2013 (FR) 1351072

(51) Int. Cl. G06F 17/50

(52) U.S. Cl. CPC G06F 17/5009
USPC 703/6

(57) ABSTRACT

A method can include formulating a linear system of equations for an implicit function with respect to a mesh that represents a geologic environment; solving the linear system of equations as a first sub-system subject to at least one second order smoothness constraint and at least a portion of data and as a second sub-system subject to at least one first order smoothness constraint and at least a portion of the data; and, based at least in part on the solving, outputting values for the implicit function with respect to at least a portion of the mesh. Various other apparatuses, systems, methods, etc., are also disclosed.

### RELATED APPLICATION

This application claims priority to and the benefit of Patent Application FR (France) 1351072, filed 7 Feb. 2013, entitled “Method for modeling of a set of conformable horizons with large dip and thickness variations using implicit functions”, to inventors François Lepage and Laurent Souche, the disclosure of which is incorporated by reference herein in its entirety.

### BACKGROUND

Phenomena associated with a sedimentary basin may be modeled using a mesh, a grid, etc. As an example, a structural model may be created based on data associated with a sedimentary basin. For example, where a basin includes various types of features (e.g., stratigraphic layers, faults, etc.), data associated with such features may be used to create a structural model of the basin. Such a model may be a basis for analysis, further modeling, etc. Various technologies, techniques, etc., described herein pertain to structural modeling, structural models, etc.

### SUMMARY

A method can include determining or otherwise formulating a linear system of equations for an implicit function with respect to a mesh that represents a geologic environment; solving the linear system of equations as a first sub-system subject to at least one second order smoothness constraint and at least a portion of data and as a second sub-system subject to at least one first order smoothness constraint and at least a portion of the data; and, based at least in part on the solving, outputting values for the implicit function with respect to at least a portion of the mesh. A method can include receiving data for a geologic environment; extracting a portion of the data to define extracted data and remaining data; determining or otherwise formulating a linear system of equations for an implicit function with respect to a mesh that represents the geologic environment; solving the linear system of equations subject to at least one constraint and the remaining data for implicit function values; calculating stratigraphy property values based at least in part on the extracted data and the implicit function values; and, based at least in part on the calculating, outputting the stratigraphy property values with respect to at least a portion of the mesh. Various other apparatuses, systems, methods, etc., are also disclosed.

This summary is provided to introduce a selection of concepts that are further described below in the detailed description. This summary is not intended to identify key or essential features of the claimed subject matter, nor is it intended to be used as an aid in limiting the scope of the claimed subject matter.

### BRIEF DESCRIPTION OF THE DRAWINGS

Features and advantages of the described implementations can be more readily understood by reference to the following description taken in conjunction with the accompanying drawings.

FIG. 1 illustrates an example system that includes various components for simulating a geological environment;

FIG. 2 illustrates an example of a system;

FIG. 3 illustrates examples of a method, a convention, constraints and equations;

FIG. 4 illustrates an example of a system and an example of a method;

FIG. 5 illustrates examples of methods;

FIG. 6 illustrates an example of a method, examples of plots and examples of equations;

FIG. 7 illustrates example of plots of results from two methods;

FIG. 8 illustrates an example of a method;

FIG. 9 illustrates an example of plots associated with a method;

FIG. 10 illustrates examples of plots associated with two methods;

FIG. 11 illustrates examples of plots associated with a method;

FIG. 12 illustrates examples of plots associated with a method;

FIG. 13 illustrates examples of plots associated with a method;

FIG. 14 illustrates examples of plots associated with a method; and

FIG. 15 illustrates example components of a system and a networked system.

### DETAILED DESCRIPTION

The following description includes the best mode presently contemplated for practicing the described implementations. This description is not to be taken in a limiting sense, but rather is made merely for the purpose of describing the general principles of the implementations. The scope of the described implementations should be ascertained with reference to the issued claims.

Phenomena associated with a sedimentary basin (e.g., a subsurface region, whether below a ground surface, water surface, etc.) may be modeled using a model or models. As an example, a structural model of a basin may find use for understanding various processes related to exploration and production of natural resources (estimating reserves in place, drilling wells, forecasting production, etc.). As an example, a structural model may be used as a basis for building a model for use with a numerical technique.

For application of a numerical technique, equations may be discretized using a grid that includes nodes, cells, etc. To represent features in a geologic environment, a structural model may assist with properly locating nodes, cells, etc. of a grid for use in simulation using one or more numerical techniques. As an example, a structural model may itself include a mesh, which may, at times be referred to as a grid. As an example, a structural model may provide for analysis optionally without resorting to creation of a grid suited for discretization of equations for a numerical solver (e.g., consider a structured grid that may reduce computational demands, etc.).

As to numerical techniques, a numerical technique such as the finite difference method can include discretizing a 1D differential heat equation for temperature with respect to a spatial coordinate to approximate temperature derivatives (e.g., first order, second order, etc.). Where time is of interest, a derivative of temperature with respect to time may also be provided. As to the spatial coordinate, the numerical technique may rely on a spatial grid that includes various nodes where a temperature will be provided for each node upon solving the heat equation (e.g., subject to boundary conditions, generation terms, etc.). Such an example may apply to multiple dimensions in space (e.g., where discretization is applied to the multiple dimensions). Thus, a grid may discretize a volume of interest (VOI) into elementary elements (e.g., cells or grid blocks) that may be assigned or associated with properties (e.g. porosity, rock type, etc.), which may be germane to simulation of physical processes (e.g., fluid flow, reservoir compaction, etc.).

As another example of a numerical technique, consider the finite element method where space may be represented by one dimensional or multidimensional “elements”. For one spatial dimension, an element may be represented by two nodes positioned along a spatial coordinate. For multiple spatial dimensions, an element may include any number of nodes. Further, some equations may be represented by certain nodes while others are represented by fewer nodes (e.g., consider an example for the Navier-Stokes equations where fewer nodes represent pressure). The finite element method may include providing nodes that can define triangular elements (e.g., tetrahedra in 3D, higher order simplexes in multidimensional spaces, etc.) or quadrilateral elements (e.g., hexahedra or pyramids in 3D. etc.), or polygonal elements (e.g., prisms in 3D, etc.). Such elements, as defined by corresponding nodes of a grid, may be referred to as grid cells.

Yet another example of a numerical technique is the finite volume method. For the finite volume method, values for model equation variables may be calculated at discrete places on a grid, for example, a node of the grid that includes a “finite volume” surrounding it. The finite volume method may apply the divergence theorem for evaluation of fluxes at surfaces of each finite volume such that flux entering a given finite volume equals that leaving to one or more adjacent finite volumes (e.g., to adhere to conservation laws). For the finite volume method, nodes of a grid may define grid cells.

As mentioned, where a sedimentary basin (e.g., subsurface region) includes various types of features (e.g., stratigraphic layers, faults, etc.) where nodes, cells, etc. of a mesh or grid may represent, or be assigned to, such features. As an example, consider a structural model that may include one or more meshes. Such a model may serve as a basis for formation of a grid for discretized equations to represent a sedimentary basin and its features.

As to a stratigraphic sequence, a sedimentary basin may include sedimentary deposits grouped into stratigraphic units, for example, based on any of a variety of factors, to approximate or represent time lines that place stratigraphy in a chronostratigraphic framework. While sequence stratigraphy is mentioned, lithostratigraphy may be applied, for example, based on similarity of lithology of rock units (e.g., rather than time-related factors).

As an example, a mesh may conform to structural features such as, for example, Y-faults, X-faults, low-angle unconformities, salt bodies, intrusions, etc. (e.g., geological discontinuities), to more fully capture complexity of a geological model. As an example, a mesh may optionally conform to stratigraphy (e.g., in addition to one or more geological discontinuities). As to geological discontinuities, these may include model discontinuities such as one or more model boundaries. As an example, a mesh may be populated with property fields generated, for example, by geostatistical methods.

In general, a relationship may exist between node spacing and phenomenon or phenomena being modeled. Various scales may exist within a geologic environment, for example, a molecular scale may be on the order of approximately 10⁻⁹ to approximately 10⁻⁸ meters, a pore scale may be on the order of approximately 10⁻⁶ to approximately 10⁻³ meters, bulk continuum may be on the order of approximately 10⁻³ to approximately 10⁻² meters, and a basin scale on the order of approximately 10³ to approximately 10⁵ meters. As an example, nodes of a mesh may be selected based at least in part on the type of phenomenon or phenomena being modeled (e.g., to select nodes of appropriate spacing or spacings). As an example, nodes of a grid may include node-to-node spacing of about 10 meters to about 500 meters. In such an example, a basin being modeled may span, for example, over approximately 10³ meters. As an example, node-to-node space may vary, for example, being smaller or larger than the aforementioned spacings.

Some data may be involved in building an initial mesh and, thereafter, a model, a corresponding mesh, etc. may optionally be updated in response to model output, changes in time, physical phenomena, additional data, etc. Data may include one or more of the following: depth or thickness maps and fault geometries and timing from seismic, remote-sensing, electromagnetic, gravity, outcrop and well log data. Furthermore, data may include depth and thickness maps stemming from facies variations.

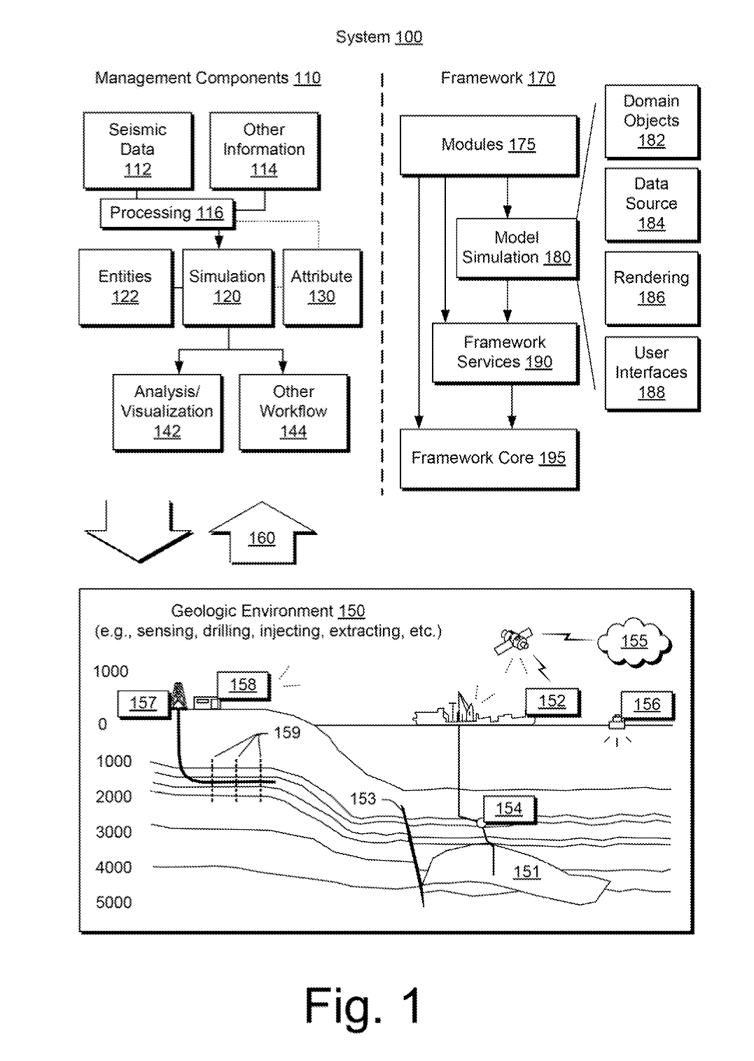

FIG. 1 shows an example of a system 100 that includes various management components 110 to manage various aspects of a geologic environment 150 (e.g., an environment that includes a sedimentary basin, a reservoir 151, one or more fractures 153, etc.). For example, the management components 110 may allow for direct or indirect management of sensing, drilling, injecting, extracting, etc., with respect to the geologic environment 150. In turn, further information about the geologic environment 150 may become available as feedback 160 (e.g., optionally as input to one or more of the management components 110).

In the example of FIG. 1, the management components 110 include a seismic data component 112, an additional information component 114 (e.g., well/logging data), a processing component 116, a simulation component 120, an attribute component 130, an analysis/visualization component 142 and a workflow component 144. In operation, seismic data and other information provided per the components 112 and 114 may be input to the simulation component 120.

In an example embodiment, the simulation component 120 may rely on entities 122. Entities 122 may include earth entities or geological objects such as wells, surfaces, reservoirs, etc. In the system 100, the entities 122 can include virtual representations of actual physical entities that are reconstructed for purposes of simulation. The entities 122 may include entities based on data acquired via sensing, observation, etc. (e.g., the seismic data 112 and other information 114). An entity may be characterized by one or more properties (e.g., a geometrical pillar grid entity of an earth model may be characterized by a porosity property). Such properties may represent one or more measurements (e.g., acquired data), calculations, etc.

In an example embodiment, the simulation component 120 may operate in conjunction with a software framework such as an object-based framework. In such a framework, entities may include entities based on pre-defined classes to facilitate modeling and simulation. A commercially available example of an object-based framework is the MICROSOFT® .NET™ framework (Redmond, Wash.), which provides a set of extensible object classes. In the .NET™ framework, an object class encapsulates a module of reusable code and associated data structures. Object classes can be used to instantiate object instances for use in by a program, script, etc. For example, borehole classes may define objects for representing boreholes based on well data.

In the example of FIG. 1, the simulation component 120 may process information to conform to one or more attributes specified by the attribute component 130, which may include a library of attributes. Such processing may occur prior to input to the simulation component 120 (e.g., consider the processing component 116). As an example, the simulation component 120 may perform operations on input information based on one or more attributes specified by the attribute component 130. In an example embodiment, the simulation component 120 may construct one or more models of the geologic environment 150, which may be relied on to simulate behavior of the geologic environment 150 (e.g., responsive to one or more acts, whether natural or artificial). In the example of FIG. 1, the analysis/visualization component 142 may allow for interaction with a model or model-based results (e.g., simulation results, etc.). As an example, output from the simulation component 120 may be input to one or more other workflows, as indicated by a workflow component 144.

As an example, the simulation component 120 may include one or more features of a simulator such as the ECLIPSE™ reservoir simulator (Schlumberger Limited, Houston Tex.), the INTERSECT™ reservoir simulator (Schlumberger Limited, Houston Tex.), etc. As an example, a reservoir or reservoirs may be simulated with respect to one or more enhanced recovery techniques (e.g., consider a thermal process such as SAGD, etc.).

In an example embodiment, the management components 110 may include features of a commercially available framework such as the PETREL® seismic to simulation software framework (Schlumberger Limited, Houston, Tex.). The PETREL® framework provides components that allow for optimization of exploration and development operations. The PETREL® framework includes seismic to simulation software components that can output information for use in increasing reservoir performance, for example, by improving asset team productivity. Through use of such a framework, various professionals (e.g., geophysicists, geologists, and reservoir engineers) can develop collaborative workflows and integrate operations to streamline processes. Such a framework may be considered an application and may be considered a data-driven application (e.g., where data is input for purposes of modeling, simulating, etc.).

In an example embodiment, various aspects of the management components 110 may include add-ons or plug-ins that operate according to specifications of a framework environment. For example, a commercially available framework environment marketed as the OCEAN® framework environment (Schlumberger Limited, Houston. Tex.) allows for integration of add-ons (or plug-ins) into a PETREL® framework workflow. The OCEAN® framework environment leverages .NET® tools (Microsoft Corporation, Redmond, Wash.) and offers stable, user-friendly interfaces for efficient development. In an example embodiment, various components may be implemented as add-ons (or plug-ins) that conform to and operate according to specifications of a framework environment (e.g., according to application programming interface (API) specifications, etc.).

FIG. 1 also shows an example of a framework 170 that includes a model simulation layer 180 along with a framework services layer 190, a framework core layer 195 and a modules layer 175. The framework 170 may include the commercially available OCEAN® framework where the model simulation layer 180 is the commercially available PETREL® model-centric software package that hosts OCEAN® framework applications. In an example embodiment, the PETREL® software may be considered a data-driven application. The PETREL® software can include a framework for model building and visualization. Such a model may include one or more grids.

The model simulation layer 180 may provide domain objects 182, act as a data source 184, provide for rendering 186 and provide for various user interfaces 188. Rendering 186 may provide a graphical environment in which applications can display their data while the user interfaces 188 may provide a common look and feel for application user interface components.

In the example of FIG. 1, the domain objects 182 can include entity objects, property objects and optionally other objects. Entity objects may be used to geometrically represent wells, surfaces, reservoirs, etc., while property objects may be used to provide property values as well as data versions and display parameters. For example, an entity object may represent a well where a property object provides log information as well as version information and display information (e.g., to display the well as part of a model).

In the example of FIG. 1, data may be stored in one or more data sources (or data stores, generally physical data storage devices), which may be at the same or different physical sites and accessible via one or more networks. The model simulation layer 180 may be configured to model projects. As such, a particular project may be stored where stored project information may include inputs, models, results and cases. Thus, upon completion of a modeling session, a user may store a project. At a later time, the project can be accessed and restored using the model simulation layer 180, which can recreate instances of the relevant domain objects.

In the example of FIG. 1, the geologic environment 150 may include layers (e.g., stratification) that include a reservoir 151 and that may be intersected by a fault 153. As an example, the geologic environment 150 may be outfitted with any of a variety of sensors, detectors, actuators, etc. For example, equipment 152 may include communication circuitry to receive and to transmit information with respect to one or more networks 155. Such information may include information associated with downhole equipment 154, which may be equipment to acquire information, to assist with resource recovery, etc. Other equipment 156 may be located remote from a well site and include sensing, detecting, emitting or other circuitry. Such equipment may include storage and communication circuitry to store and to communicate data, instructions, etc. As an example, one or more satellites may be provided for purposes of communications, data acquisition, etc. For example, FIG. 1 shows a satellite in communication with the network 155 that may be configured for communications, noting that the satellite may additionally or alternatively include circuitry for imagery (e.g., spatial, spectral, temporal, radiometric, etc.).

FIG. 1 also shows the geologic environment 150 as optionally including equipment 157 and 158 associated with a well that includes a substantially horizontal portion that may intersect with one or more fractures 159. For example, consider a well in a shale formation that may include natural fractures, artificial fractures (e.g., hydraulic fractures) or a combination of natural and artificial fractures. As an example, a well may be drilled for a reservoir that is laterally extensive. In such an example, lateral variations in properties, stresses, etc. may exist where an assessment of such variations may assist with planning, operations, etc. to develop a laterally extensive reservoir (e.g., via fracturing, injecting, extracting, etc.). As an example, the equipment 157 and/or 158 may include components, a system, systems, etc. for fracturing, seismic sensing, analysis of seismic data, assessment of one or more fractures, etc.

As mentioned, the system 100 may be used to perform one or more workflows. A workflow may be a process that includes a number of worksteps. A workstep may operate on data, for example, to create new data, to update existing data, etc. As an example, a may operate on one or more inputs and create one or more results, for example, based on one or more algorithms. As an example, a system may include a workflow editor for creation, editing, executing, etc. of a workflow. In such an example, the workflow editor may provide for selection of one or more pre-defined worksteps, one or more customized worksteps, etc. As an example, a workflow may be a workflow implementable in the PETREL® software, for example, that operates on seismic data, seismic attribute(s), etc. As an example, a workflow may be a process implementable in the OCEAN® framework. As an example, a workflow may include one or more worksteps that access a module such as a plug-in (e.g. external executable code, etc.).

As an example, a method may include structural modeling, for example, building a structural model, editing a structural model, etc. of a geologic environment. As an example, a workflow may include providing a structural model prior to construction of a grid (e.g., using the structural model), which may, in turn, be suitable for use with one or more numerical techniques. As an example, one or more applications may operate on a structural model (e.g., input of a structural model).

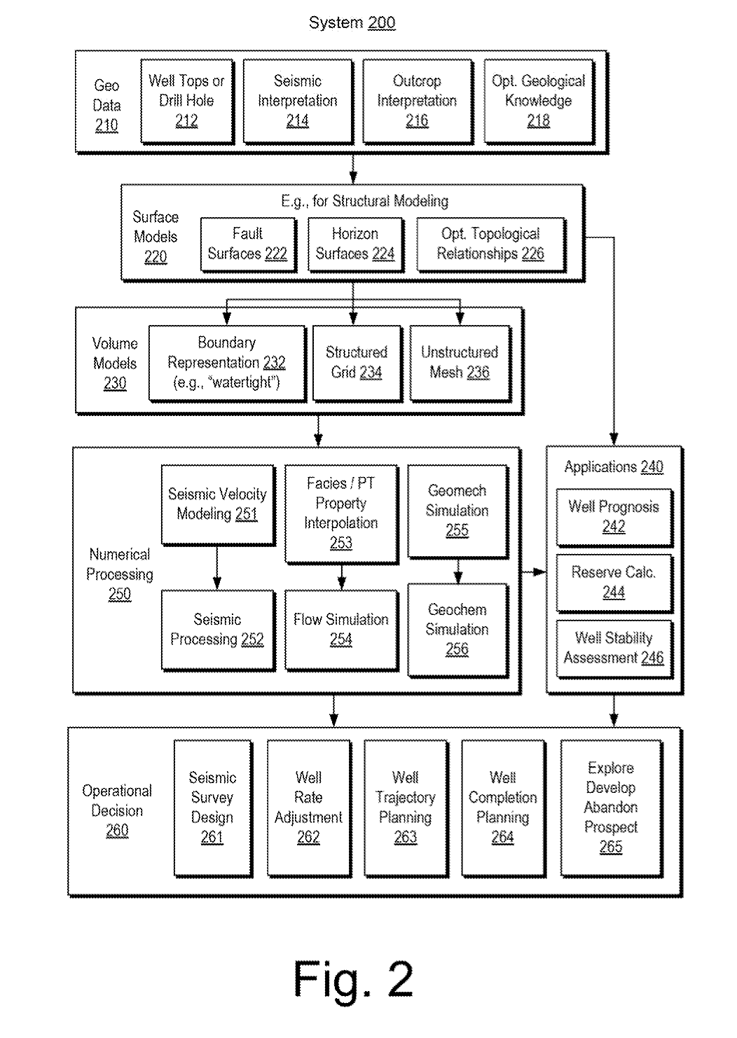

FIG. 2 shows an example of a system 200 that includes a geological/geophysical data block 210, a surface models block 220 (e.g., for one or more structural models), a volume modules block 230, an applications block 240, a numerical processing block 250 and an operational decision block 260. As shown in the example of FIG. 2, the geological/geophysical data block 210 can include data from well tops or drill holes 212, data from seismic interpretation 214, data from outcrop interpretation and optionally data from geological knowledge. As to the surface models block 220, it may provide for creation, editing, etc. of one or more surface models based on, for example, one or more of fault surfaces 222, horizon surfaces 224 and optionally topological relationships 226. As to the volume models block 230, it may provide for creation, editing, etc. of one or more volume models based on, for example, one or more of boundary representations 232 (e.g., to form a watertight model), structured grids 234 and unstructured meshes 236.

As shown in the example of FIG. 2, the system 200 may allow for implementing one or more workflows, for example, where data of the data block 210 are used to create, edit, etc. one or more surface models of the surface models block 220, which may be used to create, edit, etc. one or more volume models of the volume models block 230. As indicated in the example of FIG. 2, the surface models block 220 may provide one or more structural models, which may be input to the applications block 240. For example, such a structural model may be provided to one or more applications, optionally without performing one or more processes of the volume models block 230 (e.g., for purposes of numerical processing by the numerical processing block 250). Accordingly, the system 200 may be suitable for one or more workflows for structural modeling (e.g., optionally without performing numerical processing per the numerical processing block 250).

As to the applications block 240, it may include applications such as a well prognosis application 242, a reserve calculation application 244 and a well stability assessment application 246. As to the numerical processing block 250, it may include a process for seismic velocity modeling 251 followed by seismic processing 252, a process for facies and petrotechnical property interpolation 253 followed by flow simulation 254, and a process for geomechanical simulation 255 followed by geochemical simulation 256. As indicated, as an example, a workflow may proceed from the volume models block 230 to the numerical processing block 250 and then to the applications block 240 and/or to the operational decision block 260. As another example, a workflow may proceed from the surface models block 220 to the applications block 240 and then to the operational decisions block 260 (e.g., consider an application that operates using a structural model).

In the example of FIG. 2, the operational decisions block 260 may include a seismic survey design process 261, a well rate adjustment process 252, a well trajectory planning process 263, a well completion planning process 264 and a process for one or more prospects, for example, to decide whether to explore, develop, abandon, etc. a prospect.

Referring again to the data block 210, the well tops or drill hole data 212 may include spatial localization, and optionally surface dip, of an interface between two geological formations or of a subsurface discontinuity such as a geological fault; the seismic interpretation data 214 may include a set of points, lines or surface patches interpreted from seismic reflection data, and representing interfaces between media (e.g., geological formations in which seismic wave velocity differs) or subsurface discontinuities; the outcrop interpretation data 216 may include a set of lines or points, optionally associated with measured dip, representing boundaries between geological formations or geological faults, as interpreted on the earth surface; and the geological knowledge data 218 may include, for example knowledge of the paleo-tectonic and sedimentary evolution of a region.

As to a structural model, it may be, for example, a set of gridded or meshed surfaces representing one or more interfaces between geological formations (e.g., horizon surfaces) or mechanical discontinuities (fault surfaces) in the subsurface. As an example, a structural model may include some information about one or more topological relationships between surfaces (e.g. fault A truncates fault B, fault B intersects fault C, etc.).

As to the one or more boundary representations 232, they may include a numerical representation in which a subsurface model is partitioned into various closed units representing geological layers and fault blocks wherein an individual unit may be defined by its boundary and, optionally, by a set of internal boundaries such as fault surfaces.

As to the one or more structured grids 234, it may include a grid that partitions a volume of interest into different elementary volumes (cells), for example, that may be indexed according to a pre-defined, repeating pattern. As to the one or more unstructured meshes 236, it may include a mesh that partitions a volume of interest into different elementary volumes, for example, that may not be readily indexed following a pre-defined, repeating pattern (e.g., consider a Cartesian cube with indexes I, J, and K, along x, y, and z axes).

As to the seismic velocity modeling 251, it may include calculation of velocity of propagation of seismic waves (e.g., where seismic velocity depends on type of seismic wave and on direction of propagation of the wave). As to the seismic processing 252, it may include a set of processes allowing identification of localization of seismic reflectors in space, physical characteristics of the rocks in between these reflectors, etc.

As to the facies and petrophysical property interpolation 253, it may include an assessment of type of rocks and of their petrophysical properties (e.g. porosity, permeability), for example, optionally in areas not sampled by well logs or coring. As an example, such an interpolation may be constrained by interpretations from log and core data, and by prior geological knowledge.

As to the flow simulation 254, as an example, it may include simulation of flow of hydro-carbons in the subsurface, for example, through geological times (e.g., in the context of petroleum systems modeling, when trying to predict the presence and quality of oil in an un-drilled formation) or during the exploitation of a hydrocarbon reservoir (e.g., when some fluids are pumped from or into the reservoir).

As to geomechanical simulation 255, it may include simulation of the deformation of rocks under boundary conditions. Such a simulation may be used, for example, to assess compaction of a reservoir (e.g., associated with its depletion, when hydrocarbons are pumped from the porous and deformable rock that composes the reservoir). As an example a geomechanical simulation may be used for a variety of purposes such as, for example, prediction of fracturing, reconstruction of the paleo-geometries of the reservoir as they were prior to tectonic deformations, etc.

As to geochemical simulation 256, such a simulation may simulate evolution of hydrocarbon formation and composition through geological history (e.g., to assess the likelihood of oil accumulation in a particular subterranean formation while exploring new prospects).

As to the various applications of the applications block 240, the well prognosis application 242 may include predicting type and characteristics of geological formations that may be encountered by a drill-bit, and location where such rocks may be encountered (e.g., before a well is drilled); the reserve calculations application 244 may include assessing total amount of hydrocarbons or ore material present in a subsurface environment (e.g., and estimates of which proportion can be recovered, given a set of economic and technical constraints); and the well stability assessment application 246 may include estimating risk that a well, already drilled or to-be-drilled, will collapse or be damaged due underground stress.

As to the operational decision block 260, the seismic survey design process 261 may include deciding where to place seismic sources and receivers to optimize the coverage and quality of the collected seismic information while minimizing cost of acquisition; the well rate adjustment process 262 may include controlling injection and production well schedules and rates (e.g., to maximize recovery and production); the well trajectory planning process 263 may include designing a well trajectory to maximize potential recovery and production while minimizing drilling risks and costs; the well trajectory planning process 264 may include selecting proper well tubing, casing and completion (e.g., to meet expected production or injection targets in specified reservoir formations); and the prospect process 265 may include decision making, in an exploration context, to continue exploring, start producing or abandon prospects (e.g., based on an integrated assessment of technical and financial risks against expected benefits).

As an example, a method may include implicit modeling that includes using one or more implicit functions. As an example, such a method can include representing geological horizons in three-dimensions using specific iso-surfaces of a scalar property field (e.g., an implicit function) defined on a three-dimensional background mesh.

As an example, a method that includes implicit modeling may assist with exploration and production of natural resources such as, for example, hydrocarbons or minerals. As an example, such a method may include modeling one or more faulted structures that may include geological layers that vary spatially in thickness. As an example, such a method may be employed to model large (basin) scale areas, syn-tectonic deposition, etc.

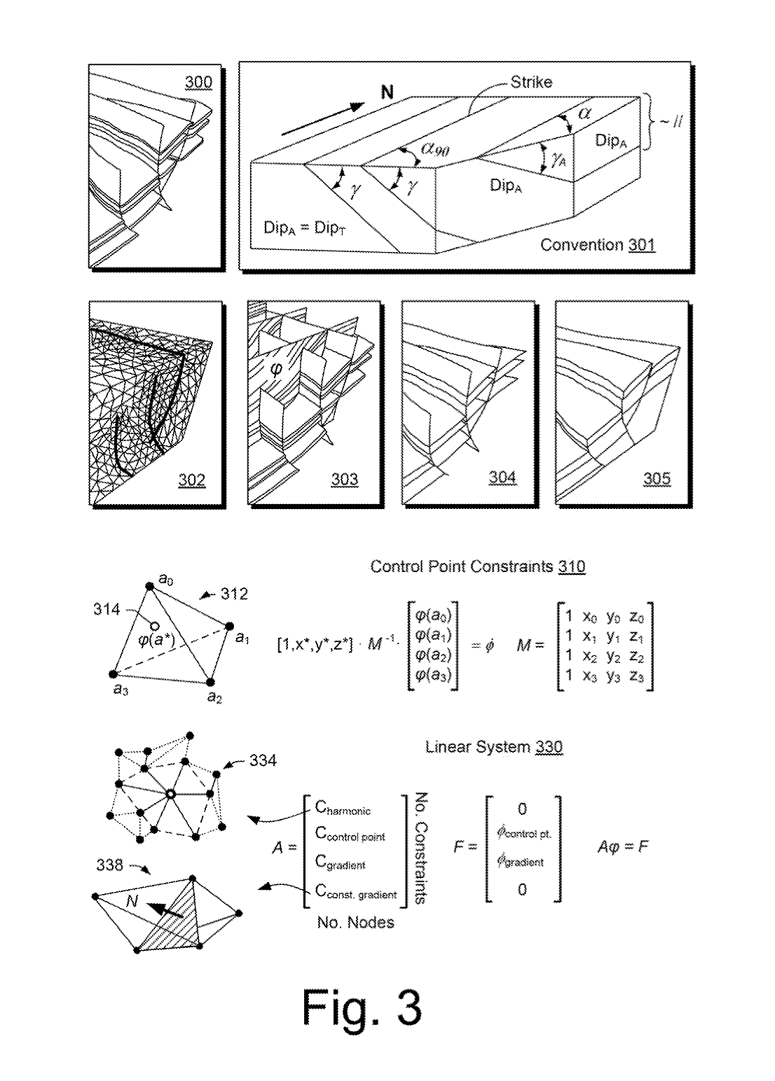

FIG. 3 shows an example of a plot of a geologic environment 300 that may be represented in part by a convention 301. As an example, a method may employ implicit modeling to analyze the geologic environment, for example, as shown in the plots 302, 303, 304 and 305. FIG. 3 also shows an example of a control point constraints formulation 310 and an example of a linear system of equations determination or formulation 330 (hereinafter, “formulation 330”), which pertain to an implicit function (φ).

In FIG. 3, the plot of the geologic environment 300 may be based at least in part on input data, for example, related to one or more fault surfaces, horizon points, etc. As an example, one or more features in such a geologic environment may be characterized in part by dip.

As an example, dip may be specified according to the convention 301, as graphically illustrated in FIG. 3. As shown by the convention 301, the three dimensional orientation of a plane may be defined by its dip and strike. Per the convention 301, dip is the angle of slope of a plane from a horizontal plane (e.g., an imaginary plane) measured in a vertical plane in a specific direction. Dip may be defined by magnitude (e.g., also known as angle or amount) and azimuth (e.g., also known as direction). As shown in the convention 301 of FIG. 3, various angles γ indicate angle of slope downwards, for example, from an imaginary horizontal plane (e.g., flat upper surface); whereas, azimuth refers to the direction towards which a dipping plane slopes (e.g., which may be given with respect to degrees, compass directions, etc.). In the convention 301, various angles are represented by the Greek letter gamma as the Greek letter phi appears in association with various examples that include implicit modeling. Another feature shown in the convention 301 of FIG. 3 is strike, which is the orientation of the line created by the intersection of a dipping plane and a horizontal plane (e.g., consider the flat upper surface as being an imaginary horizontal plane).

Some additional terms related to dip and strike may apply to an analysis, for example, depending on circumstances, orientation of collected data, etc. One term is “true dip” (see, e.g., Dip_{T} in the convention 301 of FIG. 3). True dip is the dip of a plane measured directly perpendicular to strike (see, e.g., line directed northwardly and labeled “strike” and angle α₉₀) and also the maximum possible value of dip magnitude. Another term is “apparent dip” (see, e.g., Dip_{A} in the convention 301 of FIG. 3). Apparent dip may be the dip of a plane as measured in any other direction except in the direction of true dip (see, e.g., γ_{A} as Dip_{A} for angle α); however, it is possible that the apparent dip is equal to the true dip (see, e.g., γ as Dip_{A}=Dip_{T} for angle α₉₀ with respect to the strike). In other words, where the term apparent dip is used (e.g., in a method, analysis, algorithm, etc.), for a particular dipping plane, a value for “apparent dip” may be equivalent to the true dip of that particular dipping plane.

As shown in the convention 301 of FIG. 3, the dip of a plane as seen in a cross-section perpendicular to the strike is true dip (see, e.g., the surface with γ as Dip_{A}=Dip_{T} for angle α₉₀ with respect to the strike). As indicated, dip observed in a cross-section in any other direction is apparent dip (see, e.g., surfaces labeled Dip_{A}). Further, as shown in the convention 301 of FIG. 3, apparent dip may be approximately 0 degrees (e.g. parallel to a horizontal surface where an edge of a cutting plane runs along a strike direction).

In terms of observing dip in wellbores, true dip is observed in wells drilled vertically. In wells drilled in any other orientation (or deviation), the dips observed are apparent dips (e.g., which are referred to by some as relative dips). In order to determine true dip values for planes observed in such boreholes, as an example, a vector computation (e.g., based on the borehole deviation) may be applied to one or more apparent dip values.

As mentioned, another term that finds use in sedimentological interpretations from borehole images is “relative dip” (e.g., Dip_{R}). A value of true dip measured from borehole images in rocks deposited in very calm environments may be subtracted (e.g., using vector-subtraction) from dips in a sand body. In such an example, the resulting dips are called relative dips and may find use in interpreting sand body orientation.

A convention such as the convention 301 may be used with respect to an analysis, an interpretation, an attribute, a model, etc. (see, e.g., various blocks of the system 100 of FIG. 1 and the system 200 of FIG. 2). As an example, various types of features may be described, in part, by dip (e.g., sedimentary bedding, horizons, faults and fractures, cuestas, igneous dikes and sills, metamorphic foliation, etc.).

Seismic interpretation may aim to identify and classify one or more subsurface boundaries based at least in part on one or more dip parameters (e.g., angle or magnitude, azimuth, etc.). As an example, various types of features (e.g., sedimentary bedding, horizons, faults and fractures, cuestas, igneous dikes and sills, metamorphic foliation, etc.) may be described at least in part by angle, at least in part by azimuth, etc.

Referring to the plots 302, 303, 304 and 305 of FIG. 3, these may represent portions of a method that can generate a model of a geologic environment such as the geologic environment represented in the plot 300.

As an example, a volume based modeling method may include receiving input data (see, e.g., the plot 300); generating a volume mesh, which may be, for example, an unstructured tetrahedral mesh (see, e.g., the plot 302); calculating implicit function values, which may represent stratigraphy and which may be optionally rendered using a periodic map (see, e.g., the plot 303 and the implicit function φ as represented using periodic mapping); extracting one or more horizon surfaces as iso-surfaces of the implicit function (see, e.g., the plot 304); and generating a watertight model of geological layers, which may optionally be obtained by subdividing a model at least in part via implicit function values (see, e.g., the plot 305).

As an example, an implicit function calculated for a geologic environment includes isovalues that may represent stratigraphy of modeled layers. For example, depositional interfaces identified via interpretations of seismic data (e.g., signals, reflectors, etc.) and/or on borehole data (e.g., well tops, etc.) may correspond to iso-surfaces of the implicit function. As an example, where reflectors correspond to isochronous geological sequence boundaries, an implicit function may be a monotonous function of stratigraphic age of geologic formations.

As an example, a process for creating a geological model may include: building an unstructured faulted 2D mesh (e.g., if a goal is to build a cross section of a model) or a 3D mesh from a watertight representation of a fault network; representing, according to an implicit function-based volume attribute, stratigraphy by performing interpolations on the built mesh; and cutting the built mesh based at least in part on iso-surfaces of the attribute to generate a volume representation of geological layers. Such a process may include outputting one or more portions of the volume representation of the geological layers (e.g., for a particular layer, a portion of a layer, etc.).

As an example, to represent complex depositional patterns, sequences that may be separated by one or more geological unconformities may optionally be modeled using one or more volume attributes. As an example, a method may include accounting for timing of fault activity (e.g., optionally in relationship to deposition) during construction of a model, for example, by locally editing a mesh on which interpolation is performed (e.g., between processing of two consecutive conformable sequences).

Referring to the control point constraints formulation 310, a tetrahedral cell 312 is shown as including a control point 314. As an example, an implicit function may be a scalar field. As an example, an implicit function may be represented as a property or an attribute, for example, for a volume (e.g., a volume of interest). As an example, the aforementioned PETREL® framework may include a volume attribute that includes spatially defined values that represent values of an implicit function.

As an example, as shown with respect to the linear system of equations formulation 330, a function “F” may be defined for coordinates (x, y, z) and equated with an implicit function denoted φ. As to constraint values, the function F may be such that each input horizon surface “I” corresponds to a known constant value hᵢ of φ. For example, FIG. 3 shows nodes (e.g., vertices) of the cell 312 as including a₀, a₁, a₂ and a₃ as well as corresponding values of φ (see column vector). As to the values value hᵢ of φ, if a horizon I is younger than horizon J, then hᵢ>hⱼ and, if one denotes T_ij* as an average thickness between horizons I and J, then (hₖ−hᵢ)/(hⱼ−hᵢ)˜T_ik*/Tij*, for which a method can include estimating values of T_ij* before an interpolation is performed. Note that such a method may, as an example, accept lower values hᵢ of φ for younger horizons, where, for example, a constraint being that, within each conformal sequence, the values hᵢ of φ vary monotonously with respect to the age of the horizons.

As to interpolation of “F”, as an example, φ may be interpolated on nodes of a background mesh (e.g., a triangulated surface in 2D a tetrahedral mesh in 3D, a regular structured grid, quad/octrees, etc.) according to several constraints that may be honored in a least squares sense. In such an example, as the background mesh may be discontinuous along faults, interpolation may be discontinuous as well; noting that “regularization constraints” may be included, for example, for constraining smoothness of interpolated values.

As an example, a method may include using fuzzy control point constraints. For example, at a location of interpretation points, hᵢ of φ (see, e.g. point a* in FIG. 3). As an example, an interpretation point may be located at a location other than that of a node of a mesh onto which an interpolation is performed, for example, as a numerical constraint may be expressed as a linear combination of values of φ at nodes of a mesh element (e.g. a tetrahedron, tetrahedral cell, etc.) that includes the interpretation point (e.g., coefficients of a sum being barycentric coordinates of the interpretation point within the element or cell).

For example, for an interpretation point p of a horizon I located inside a tetrahedron which includes vertices are a₀, a₁, a₂ and a₃ and which barycentric coordinates are b₀, b₁, b₂ and b₃ (e.g., such that the sum of the barycentric coordinates is approximately equal to 1) in the tetrahedron, an equation may be formulated as follows:

b₀φ(a₀)+b₁φ(a₁)+b₂φ(a₂)+b₃φ(a₃)=hᵢ

where unknowns in the equation are φ(a₀), φ(a₁), φ(a₂) and φ(a₃). For example, refer to the control point φ(a*), labeled 314 in the cell 312 of the control point constraints formulation 310 of FIG. 3, with corresponding coordinates (x*,y*,z*); noting a matrix “M” for coordinates of the nodes or vertices for a₀, a₁, a₂ and a₃, (e.g., x₀, y₀, z₀ to x₃, y₃, z₃).

As an example, a number of such constraints of the foregoing type may be based on a number of interpretation points where, for example, interpretation points may be for decimated interpretation (e.g., for improving performance).

As mentioned, a process may include implementing various regularization constraints, for example, for constraining smoothness of interpolated values, of various orders (e.g., constraining smoothness of φ or of its gradient ∇φ), which may be combined, for example, through a weighted least squares scheme.

As an example, a method can include constraining the gradient ∇φ in a mesh element (e.g. a tetrahedron, a tetrahedral cell, etc.) to take an arithmetic average of values of the gradients of φ(e.g., a weighted average) with respect to its neighbors (e.g., topological neighbors). As an example, one or more weighting schemes may be applied (e.g. by volume of an element) that may, for example, include defining of a topological neighborhood (e.g., by face adjacency). As an example, two geometrically “touching” mesh elements that are located on different sides of a fault may be deemed not topological neighbors, for example, as a mesh may be “unsewn” along fault surfaces (e.g., to define a set of elements or a mesh on one side of the fault and another set of elements or a mesh on the other side of the fault).

As an example, within a mesh, if one considers a mesh element mᵢ that has n neighbors m^{j}(e.g., for a tetrahedron), one may formulate an equation of an example of a regularization constraint as follows:

$$▽ϕ ( {m}_{i} ) = \frac{1}{n} {\sum }_{j = 1}^{n} ▽ϕ ( {m}_{j} )$$

In such an example of a regularization constraint, solutions for which isovalues of the implicit function would form a “flat layer cake” or “nesting balls” geometries may be considered “perfectly smooth” (i.e. not violating the regularization constraint), it may be that a first one is targeted.

As an example, one or more constraints may be incorporated into a system in linear form. For example, hard constraints may be provided on nodes of a mesh (e.g., a control node). In such an example, data may be from force values at the location of well tops. As an example, a control gradient, or control gradient orientation, approach may be implemented to impose dip constraints.

Referring again to FIG. 3, the linear system of equations formulation 330 includes various types of constraints. For example, a formulation may include harmonic equation constraints, control point equation constraints (see, e.g., the control point constraints formulation 310), gradient equation constraints, constant gradient equation constraints, etc. As shown in FIG. 3, a matrix A may include a column for each node and a row for each constraint. Such a matrix may be multiplied by a column vector such as the column vector φ(aᵢ) (e.g., or φ), for example, where the index “i” corresponds to a number of nodes, vertices, etc. for a mesh (e.g., a double index may be used, for example, aᵢⱼ, where j represents an element or cell index). As shown in the example of FIG. 3, the product of A and the vector φ may be equated to a column vector F (e.g., including non-zero entries where appropriate, for example, consider φ_{control point} and φ_{gradient}).

FIG. 3 shows an example of a harmonic constraint graphic 334 and an example of a constant gradient constraint graphic 338. As shown per the graphic 334, nodes may be constrained by a linear equation of a harmonic constraint (e.g., by topological neighbors of a common node). As shown per the graphic 338, two tetrahedra may share a common face (cross-hatched), which is constrained to share a common value of a gradient of the implicit function φ, which, in the example of FIG. 3, constrains the value of φ at the 5 nodes of the two tetrahedra.

As an example, regularization constraints may be used to control interpolation of an implicit function, for example, by constraining variations of a gradient of the implicit function. As an example, constraints may be implemented by specifying (e.g., as a linear least square constraint) that the gradient should be similar in two co-incident elements of a mesh or, for example, by specifying that, for individual elements of a mesh, that a gradient of the implicit function should be an average of the gradients of the neighboring elements. In geological terms, such constraints may translate to (1) minimization of variations of dip and thickness of individual layers, horizontally, and (2) to minimization of the change of relative layer thicknesses, vertically.

As an example, aforementioned effects as to minimization of variations and minimization of changes may impact a resulting model. As an example, a method may include applying one or more techniques that may counter such effects, for example, by splitting a linear system of equations formulation, by splitting one or more trends, etc. As an example, one or more of such techniques may be implemented in response to input data (e.g. seismic interpretation, bore observations, etc.) that indicates that variations of dip, thickness of one or more layers exceed one or more criteria. For example, consider a criterion that acts to classify dip as being large (e.g., more than about 10 degrees of variation of dip of a geological interface), a criterion that acts to classify thickness as being varied (e.g., more than doubling of thickness of a layer from one part to another of a model), etc.

As an example, schematically, computation of an implicit function may be performed in a manner that aims to honor two types of constraints: (1) the minimization of the misfit between the interpretation data and the interpolated surfaces and (2) a regularization constraint that aims to ensure smoothness and monotonicity of an interpolated property.

As explained, values of an implicit function at nodes of a volume mesh may be determined by solving a sparse linear system of equations (see, e.g., the linear system of equations formulation 330 of FIG. 3). As shown in FIG. 3, various constraints may be applied, which may, for example, be selected in an effort to better constrain one or more features (e.g., local dip of a geological layer, etc.) by constraining a gradient of the implicit function. As an example, a solution procedure may include honoring one or more constraints in a least square sense, for example, using a weighted least square scheme that may act to balance effects of contradicting constraints in a solution for a linear system of equations.

As an example, a method may include relaxing one or more regularization constraints used for interpolating an implicit functions, for example, such that the interpolation can account for one or more high frequency thickness variations.

As an example, a method may include removing one or more low frequency trends of thickness variations from data (e.g., input data, etc.), optionally prior to performing an interpolation of an implicit function, and, for example, adding the one or more trends (e.g., as appropriate) back to the implicit function. As an example, such an approach may be applied to complex faulted reservoirs, for example, optionally independently from fault offsets.

As an example, one or more methods may be applied for interpolating an implicit function, for example, with the purpose of representing a set of conformable (e.g. non-intersecting) layers. As an example, a method may employ one or more techniques, for example, a method may employ a relaxation technique, an extraction technique or a relaxation technique and an extraction technique.

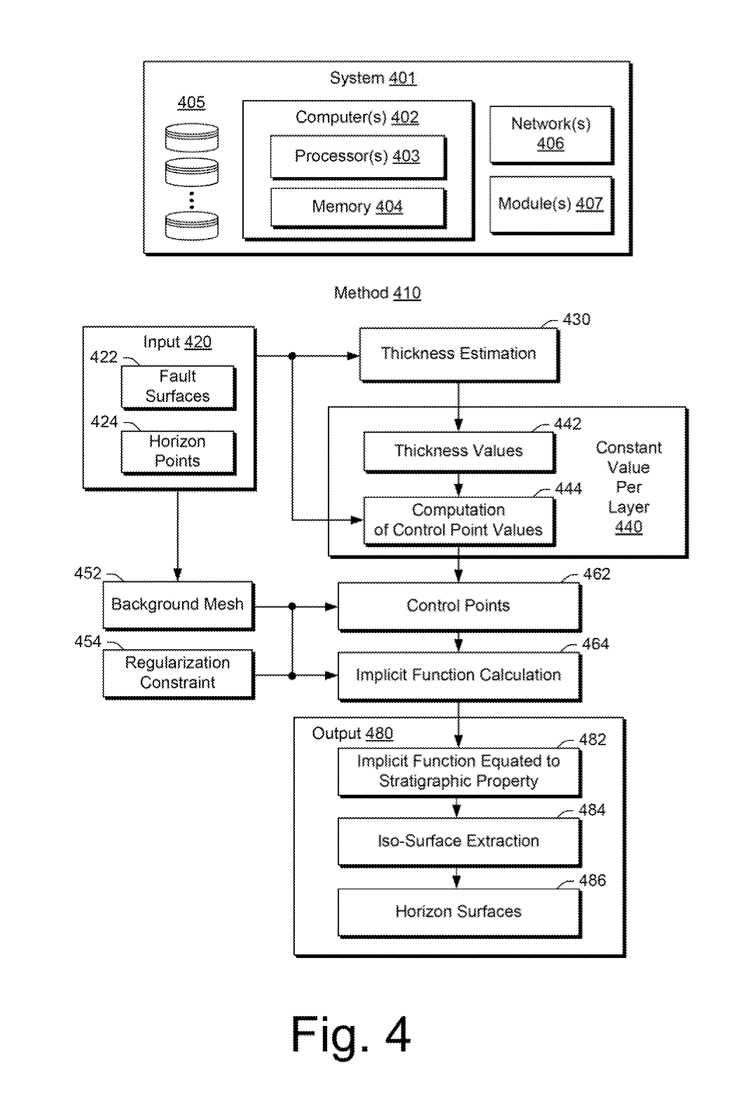

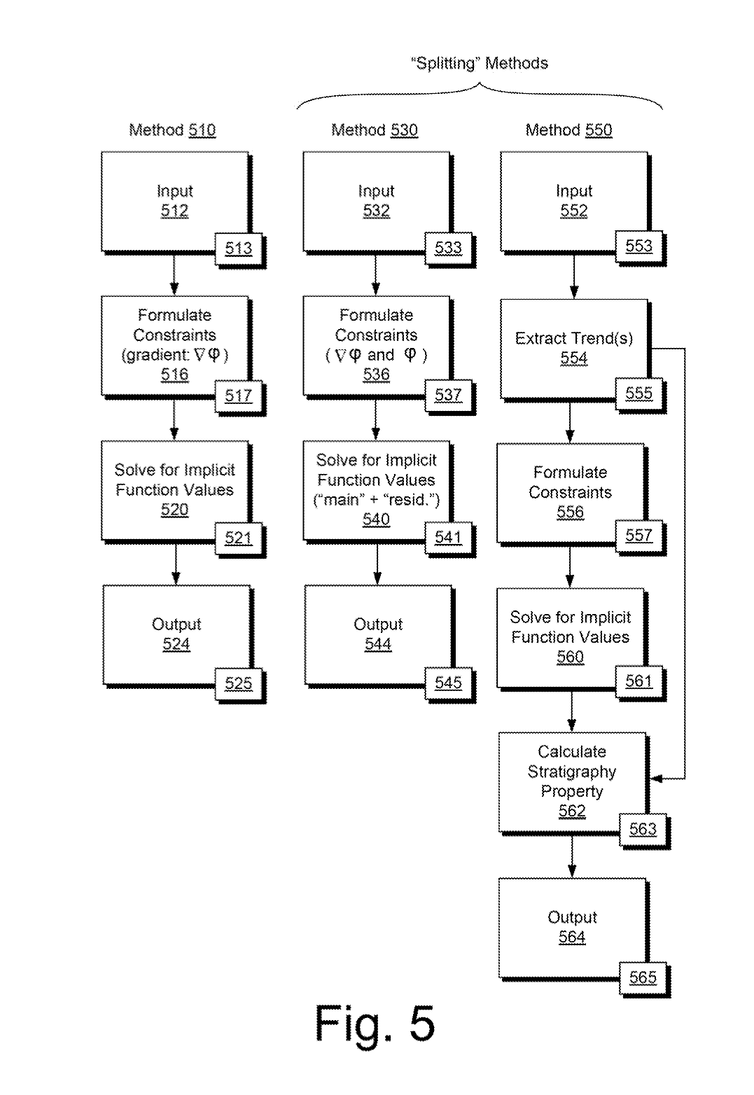

FIG. 4 shows an example of a system 401 and an example of a method 410 and FIG. 5 shows examples of methods 510, 530 and 550 where the method 510 may correspond in part to the method 410 of FIG. 4 and where the method 530 and 550 may be referred to, as an example, as “splitting” methods as the method 530 includes splitting a linear system of equations and as the method 550 includes splitting out one or more trends. As an example, the method 530 may also be referred to as a relaxation method as it may effectively relax one or more constraints (e.g., by splitting a formulation into a “main” part and a residual). As an example, the method 550 may also be referred to as an extraction method as it may effectively extract data (e.g., one or more features), for example, prior to calculation of implicit function values (e.g., to extract one or more trends). Such a method may include reintroducing extracted data (e.g., one or more features), for example, after calculating implicit function values to determine values for one or more stratigraphy properties.

FIG. 4 shows an example of a system 401 and a method 410. As shown in FIG. 4, the system 401 includes one or more computers 402, one or more storage devices 405, one or more networks 406 and one or more modules 407. As to the one or more computers 402, each computer may include one or more processors (e.g., or processing cores) 403 and memory 404 for storing instructions (e.g., modules), for example, executable by at least one of the one or more processors. As an example, a computer may include one or more network interfaces (e.g., wired or wireless), one or more graphics cards, a display interface (e.g., wired or wireless), etc. As an example, data may be provided in the storage device(s) 405 where the computer(s) 402 may access the data via the network(s) 406 and process the data via the module(s) 407, for example, as stored in the memory 404 and executed by the processor(s) 403.

FIG. 4 also shows a block diagram of the method 410, which includes an input block 420 and output block 480, for example, to output an implicit function equated to a stratigraphic property per a block 482. As to the input block 420, it may include a fault surfaces input block 422 and a horizon points input block 424. As shown in the example of FIG. 4, the input block 420 may provide input to a thickness estimation block 430, a layer block 440 and a background mesh block 452.

As to the layer block 440, it can include a thickness values block 442 for determining or receiving thickness values (e.g., based on or from the thickness estimation block 430) and a computation block 444 for computing control point values (see, e.g., the formulations 310 and 330 of FIG. 3). As shown, the layer block 440 can output control points to a control points block 462, which may be defined with respect to a mesh provided by the background mesh block 452. As an example, the control points of the control points block 462 may account for one or more regularization constraints per a regularization constraint block 454.

As an example, given control point values for layers definable with respect to a mesh and subject to one or more constraints, a method can include calculating values of an implicit function (e.g., or implicit functions). As shown in the example of FIG. 4, an implicit function calculation block 462 can receive control points and one or more constraints defined with respect to a mesh (e.g., elements, cells, nodes, vertices, etc.) and, in turn, calculate values for one or more implicit functions.

As to the output block 480, given calculated values for one or more implicit functions, these may be associated with, for example, a stratigraphic property per the block 482. As an example, one or more iso-surfaces may be extracted based at least in part on the values of the stratigraphic property per an iso-surface extraction block 484, for example, where one or more of the extracted iso-surfaces may be defined to be a horizon surface (e.g., or horizon surfaces) per a horizon surface block 486.

As mentioned, particular constraints may impact ability to model dip, thickness variations, etc., for example, due at least in part to contradictions. For example, consider the following three examples of geological situations where types of constraints (e.g., for fitting data and for regularization) may be contradictory, which may, for example, lead to unpredictable and/or undesirable behavior of an interpolated implicit function. In the three examples, large variations of dip, thickness or relative thicknesses of the layers exist locally and/or globally.

As to the first example, it pertains to a local uplift or thinning of the layers, for example, due to movement of ductile material within or below the studied area. Such features may occur on and/or above salt domes or in presence of thick shale layers. In this case, the change of dip and/or thickness of the layers may be of limited extent in a model.

As to the second example, it pertains to a global thickness change, which may be due to a lateral variation of depositional environment (e.g. proximal to distal with respect to the paleo-coast line), associated with differential sedimentation. As an example, such a scenario may occur for large, exploration scale, models.

As to the third example, it pertains to a brutal change of layer thicknesses across faults, which may be associated with the presence of syn-sedimentary faults (e.g., faults that were active while sediments were being deposited). In such scenario, thickness changes may be due to differential variation of accommodation space, for example, on both sides of a fault.

As to the method 510 of FIG. 5, it includes an input block 512 for inputting data (e.g., a reception block for receiving data), a formulation block 516 for formulating constraints (e.g., including a gradient constraint), a calculation block 520 for calculating implicit function values and an output block 524 for outputting information based at least in part on the implicit function values. As mentioned, the method 510 may include various actions of the method 410 of FIG. 4. As an example, the method 510 may include one or more contradictory constraints and/or may include input data for a feature or features of a geologic environment that may vary in a manner that may not be well-handled by one or more constraints.

As shown in FIG. 5, the method 530 includes an input block 532 for inputting data (e.g., a reception block for receiving data), a formulation block 536 for formulating constraints (e.g., including a gradient constraint and a first order constraint), a solution block 540 for solving for implicit function values using a split formulation (e.g., including a main part and a residual part) and an output block 544 for outputting information based at least in part on the implicit function values.

As shown in FIG. 5, the method 550 includes an input block 552 for inputting data (e.g., a reception block for receiving data), an extraction block 554 for extracting one or more trends from input data to provide extracted data and residual data, a formulation block 556 for formulating constraints, a solution block 560 for solving for implicit function values using the residual data, a calculation block 562 for calculating a stratigraphy property based at least in part on the implicit function values and at least in part on the extracted data and an output block 564 for outputting information based at least in part on the stratigraphy property.

The method 510 is shown in FIG. 5 in association with various computer-readable media (CRM) blocks 513, 517, 521 and 525. Such blocks generally include instructions suitable for execution by one or more processors (or cores) to instruct a computing device or system to perform one or more actions. While various blocks are shown, a single medium may be configured with instructions to allow for, at least in part, performance of various actions of the method 510. As an example, a computer-readable medium (CRM) may be a computer-readable storage medium. As an example, the blocks 513, 517, 521 and 525 may be provided as one or more modules, for example, such as the one or more modules 407 of the system 401 of FIG. 4.

The method 530 is shown in FIG. 5 in association with various computer-readable media (CRM) blocks 533, 537, 541 and 545. Such blocks generally include instructions suitable for execution by one or more processors (or cores) to instruct a computing device or system to perform one or more actions. While various blocks are shown, a single medium may be configured with instructions to allow for, at least in part, performance of various actions of the method 510. As an example, a computer-readable medium (CRM) may be a computer-readable storage medium. As an example, the blocks 533, 537, 541 and 545 may be provided as one or more modules, for example, such as the one or more modules 407 of the system 401 of FIG. 4.

The method 550 is shown in FIG. 5 in association with various computer-readable media (CRM) blocks 553, 555, 557, 561, 563 and 565. Such blocks generally include instructions suitable for execution by one or more processors (or cores) to instruct a computing device or system to perform one or more actions. While various blocks are shown, a single medium may be configured with instructions to allow for, at least in part, performance of various actions of the method 510. As an example, a computer-readable medium (CRM) may be a computer-readable storage medium. As an example, the blocks 553, 555, 557, 561, 563 and 565 may be provided as one or more modules, for example, such as the one or more modules 407 of the system 401 of FIG. 4.

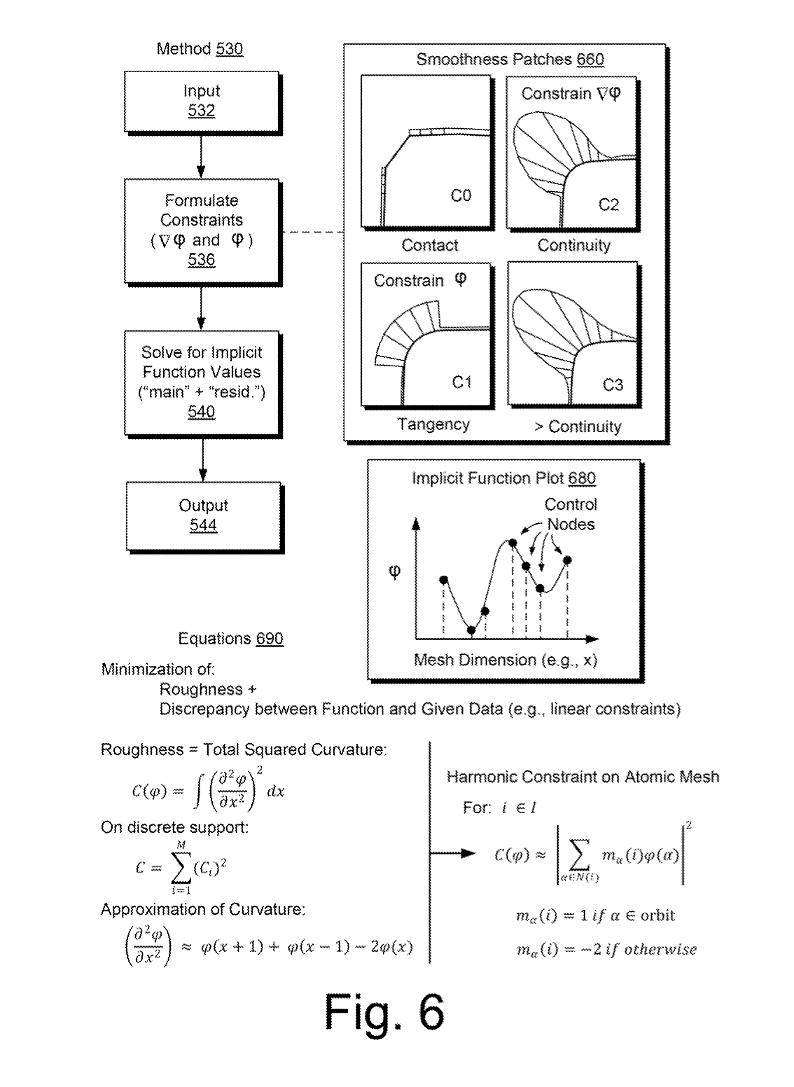

FIG. 6 shows the method 530 along with examples of plots 660 for examples of smoothness patches and an example of a plot 680 of an implicit function with respect to a mesh dimension. Various examples of equations 690 are also shown, for example, with respect to a mesh dimension x; noting that, as an example, such equations may be formulated to account for multiple dimensions.

As an example, a constraint may be a smoothness constraint. As an example, a smoothness constraint may be defined with respect to order. For example, the plots 660 include a zero order constraint (C0), a first order constraint (C1), a second order constraint (C2) and a higher order constraint (C3).

As an example, C0 may correspond to a connection without tangency (e.g., an edge), C1 may correspond to a tangent connection and C2 may correspond to a curve continuous connection. As an example, smoothness constraints may be referred to as smoothness patches or continuity constraints, for example, where: C0 may represent just touching; C1 may represent tangent, which could possibly include a sudden change in curvature; and C2 may represent continuous curvature.

As an example, the method 530 may act to accommodate local changes of dip and/or thicknesses of layers in a geologic environment. The method 530 can include splitting a linear system of equations that is used for interpolating an implicit function in to at least two portions or sub-systems. In such an example, one of the sub-systems may be constrained by a less restrictive regularization term, which may allow for larger local variations of a gradient of an implicit function.

As an example, a control point constraint may set (e.g., constrain) the value of an implicit function at a point in space. As an example, a smooth gradient constraint may constrain the gradient of an implicit function, for example, to help ensure smooth variations of the implicit function in space. As an example, a first order smoothness constraint may constrain variations in implicit function values in space. For example, given an implicit function φ, such a first order smoothness constraint may constrain φ while a second order smoothness constraint may constrain ∇φ (e.g., constrain the gradient of φ). As an example, a minimization formulation may include a main term that restrains the gradient of an implicit function and a residual term that restrains values of the implicit function. In such an example, the residual of the minimization formulation may be minimized. As an example, a roughness may be defined, for example, as an integral of square curvature. In such an example, roughness may be unaffected by addition of a constant or a linear function (e.g., roughness may be cast as a function that depends on a second derivative of a curve). As an example, a formulation may include equations that correspond to one or more of zero order, first order, second order and optionally higher order smoothness.

As an example, an implicit function may be formulated as a sum of multiple components. For example, a first component may be constrained to have a smooth gradient (C2 continuity of an interpolated value) and a second component may be constrained to have a smooth value (C1 continuity). In such an example, the first component may be considered as acting to control long-wavelength variations of the implicit function (e.g., a global trend or trends) and the second component may be considered as acting to accommodate local heterogeneities (e.g., in data). In such an example, control point, control dip and control gradient constraints may be applied to the sum of the components.

As an example, referring to the method 530, it may be described as considering an implicit function as the sum of two components (see, e.g., blocks 536 and 540). In such an example, a first component may be constrained to have a smooth gradient (C2 continuity of the interpolated value) and a second component may be constrained to have a smooth value (C1 continuity). In such an example, the first component may control long-wavelength variations of the implicit function (e.g., a global trend or trends) while the second component may accommodate local heterogeneities (e.g., as represented by input data, etc.). As an example, the method 530 may include applying control point, control dip and control gradient constraints to a sum of the first and second components.

As an example, smoothness of a second component of an implicit function may be constrained in such a way that for individual nodes at which the implicit function is defined, the difference between the value of the implicit function and the weighted value of the implicit function on adjacent nodes is minimized. In such an example, weights may be deduced from barycentric coordinates of a considered node within a polygon (e.g., in 2D) or within a polyhedron (e.g., in 3D) formed by neighboring nodes. A system of equations may then be solved, for example, by computing (e.g., simultaneously) values of a first component and a second component of an implicit function, for example, using a sparse least square solver. As an example, a formulation may include more than two components. In such an example, a system of equations may be solved for at least two of the more than two components.

As an example, the method 530 may include using a harmonic constraint on an atomic mesh as a regularization constraint. As an example, the method 530 may include constraining nodes by one linear equation of a harmonic constraint (e.g., topological neighbors of a common node; see also the graphic 334 of FIG. 3).

As an example, the method 530 may include, to help ensure uniqueness of a solution, an additional constraint for minimizing the value of an added component of an implicit function (e.g., the aforementioned second component). As an example, an implementation may act to force values of a second component (e.g., individual mesh nodes) to be dose to zero, for example, through a least square constraint. Such a constraint may also act to ensure that monotonicity of an implicit function, which may be enforced by a first component, is preserved in solution results.

As an example, the method 530 may include weighting various least square constraints with respect to each other. As an example, an input parameter (e.g., a user input parameter), translated into a weighted least square system of equations, may used to balance short and long wavelength dip and/or thickness variations. For example, in the method 530, the input block 514 may include inputting a parameter that may act to balance information based at least in part on wavelength variation, for example, as to spatial variation(s) in one or more features that may be represented at least in part by the input data input per the input block 514.

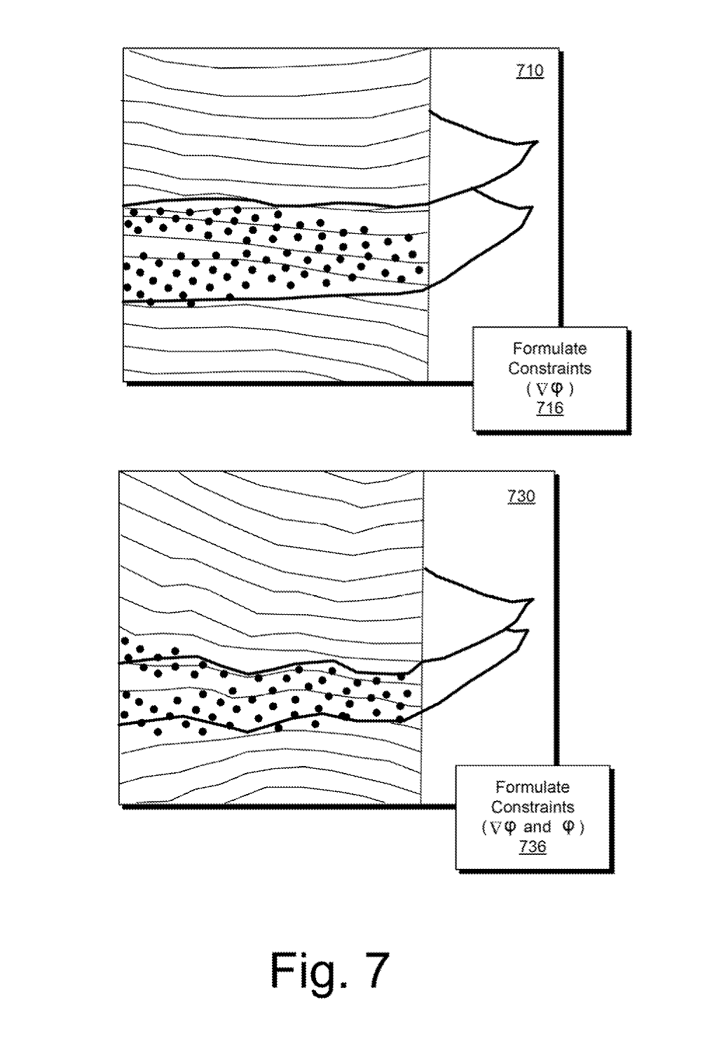

FIG. 7 shows example plots 710 and 730 for the methods 510 and 530 of FIG. 5. For example, the plot 710 corresponds to a method that includes a second order constraint (e.g., C2 constraint) and the plot 730 corresponds to a method that includes a second order constraint (e.g., C2 constraint) and a first order constraint (e.g., C1 constraint) used to formulate two components (e.g., a main component and a residual component). As shown, the horizons derived from implicit function values fit the data better in the plot 730 than in the plot 710. In particular, the plot 730 shows that implicit function values may vary more so than implicit function values in the plot 710. As such, a better match may be obtained between an implicit function and data.

As an example, a method can include receiving data for a geologic environment (see, e.g., the block 532 of the method 530); formulating a linear system of equations for an implicit function with respect to a mesh that represents the geologic environment (see, e.g., the block 536 of the method 530); solving the linear system of equations as a first sub-system (e.g., as a main sub-system) subject to at least one second order smoothness constraint (e.g., C2, to constrain ∇φ) and at least a portion of the data and as a second sub-system (e.g., as a residual sub-system) subject to at least one first order smoothness constraint (e.g., C1, to constrain φ) and at least a portion of the data (see, e.g., the block 540 of the method 530); and based at least in part on the solving, outputting values for the implicit function with respect to at least a portion of the mesh (see, e.g., the block 544 of the method 530).

As an example, a method may include a wavelength parameter that determines a first wavelength scale for a first sub-system and a second wavelength scale for a second sub-system where the first wavelength scale may be greater than the second wavelength scale. In such an example, a method may include determining a value for the wavelength parameter based at least in part on dip or variation in thickness of a layer.

As an example, a sub-system may represent a residual of another sub-system (e.g., or sub-systems). As an example, a method may include solving a linear system of equations by, in part, determining values for an implicit function by summing implicit function values associated with a first sub-system (e.g., a main sub-system) and implicit function values associated with a second sub-system (e.g., a residual sub-system). In such an example, at least one second order smoothness constraint (C2, to constrain ∇φ) may act to ensure monotonicity of the implicit function values associated with the first sub-system and solving may include minimizing the implicit function values associated with the second sub-system to help ensure monotonicity of the summed values. As an example, a method may include minimizing implicit function values associated with a sub-system by subjecting the sub-system to a least squares constraint.

As an example, a method may include receiving data for a geologic environment that includes data for a horizon that includes a dip greater than approximately 10 degrees. In such an example, a method (e.g., the method 530) may include outputting values for an implicit function by outputting an iso-value that represents the horizon.

As an example, one or more computer-readable storage media may include processor-executable instructions to instruct a system to: receive data for a geologic environment; formulate a linear system of equations for an implicit function with respect to a mesh that represents the geologic environment; solve the linear system of equations as a first sub-system subject to at least one second order smoothness constraint (e.g., C2, to constrain ∇φ) and at least a portion of the data and as a second sub-system subject to at least one first order smoothness constraint (e.g., C1, to constrain φ) and at least a portion of the data; and, based at least in part on a solution, output values for the implicit function with respect to at least a portion of the mesh.

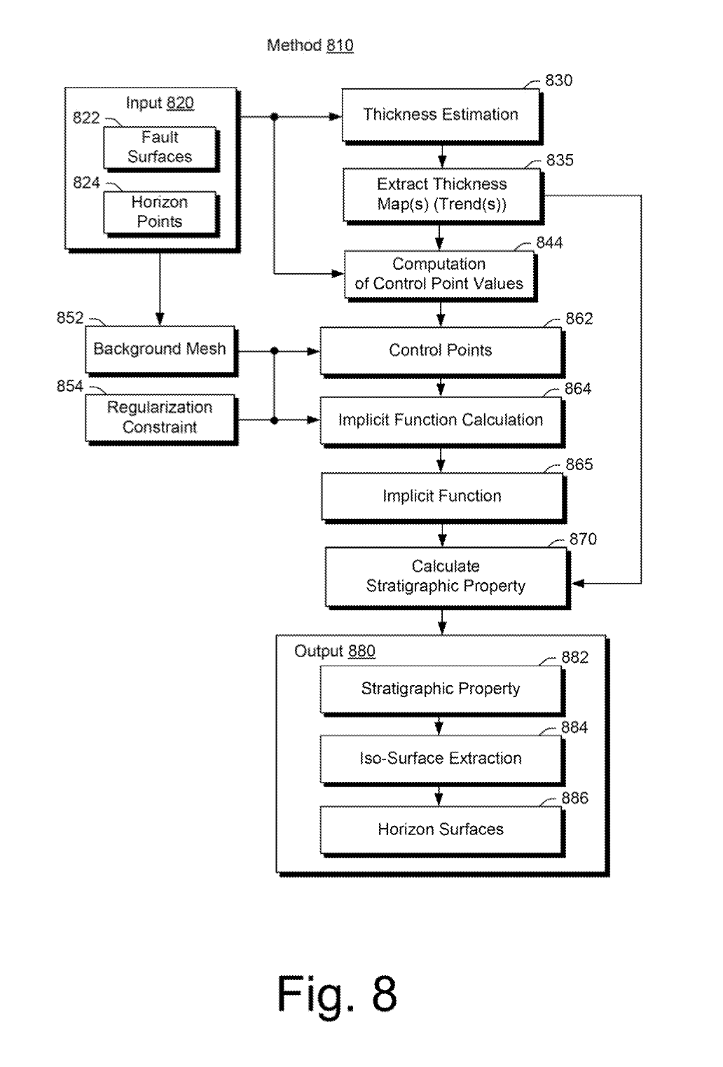

FIG. 8 shows an example of a method 810, which may include one or more of the actions described with respect to the method 550 of FIG. 5 and, for example, one or more of the actions described with respect to the method 410 of FIG. 4. As shown in FIG. 5, the method 550 includes the extraction block 554 for extracting one or more trends. For example, an extracted trend may be a global trend. As explained with respect to the method 550, extracted data that corresponds to an extracted trend may be re-introduced, for example, to determine stratigraphy property values based at least in part on implicit function values, which may have been determined without reference to the extracted data.

In FIG. 8, the method 810 includes an extraction block 835 where data extracted thereby may be reintroduced at a calculation block 870 that may include converting an implicit function (e.g., or implicit functions) to a stratigraphic property based at least in part on implicit function values and based at least in part on extracted data per the extraction block 835.

As shown, the method 810 of FIG. 8 includes an input block 820 and output block 880, for example, to output a stratigraphic property 882 based at least in part on an implicit function per a block 865 and based at least in part on extracted data per the block 835.

As to the input block 820, it may include a fault surfaces input block 822 and a horizon points input block 824. As shown in the example of FIG. 8, the input block 820 may provide input to a thickness estimation block 830, a computation of control point values block 844 and a background mesh block 852.

As shown, the block 844 can output control points to a control points block 862, which may be defined with respect to a mesh provided by the background mesh block 852. As an example, the control points of the control points block 862 may account for one or more regularization constraints per a regularization constraint block 854.

As an example, given control point values for layers definable with respect to a mesh and subject to one or more constraints, a method can include calculating values of an implicit function (e.g., or implicit functions). As shown in the example of FIG. 8, an implicit function calculation block 864 can receive control points and one or more constraints defined with respect to a mesh (e.g., elements, cells, nodes, vertices, etc.) and, in turn, calculate values for one or more implicit functions. As shown, the method 810 may output one or more implicit functions per an implicit function block 865.

As mentioned, the extraction block 835 may extract data that may be reintroduced at the calculation block 870 that may include converting an implicit function of the block 865 to a stratigraphic property based at least in part on implicit function values and based at least in part on extracted data per the extraction block 835.

As to the output block 880, given calculated values for one or more stratigraphic properties per the block 882. As an example, one or more iso-surfaces may be extracted based at least in part on the values of a stratigraphic property (e.g., or stratigraphic properties) per an iso-surface extraction block 884, for example, where one or more of the extracted iso-surfaces may be defined to be a horizon surface (e.g., or horizon surfaces) per a horizon surface block 886.

In the example method 810 of FIG. 8, in comparison to the method 410 of FIG. 4, implicit function values may lack direct correspondence to features such as horizons, for example, because horizon trend data may have been extracted prior to calculation of the implicit function values. However, as shown, through reintroduction of horizon trend data, stratigraphic property values may be calculated based at least in part on implicit function values to achieve a direct correspondence to feature such as horizons.

As an example, a method for modeling faulted horizons may include: estimating thicknesses between input horizons; creating one or more corresponding thickness maps; setting “control point” constraints for point of input horizons; adjusting a constraint value to a value of deduced from stacking (e.g., summation) of thickness maps; interpolating an implicit function using defined control point constraints and defined smoothness (e.g. constant or smooth gradient) constraints; converting the computed implicit function to a representation of stratigraphy, in which each input horizon corresponds to an iso-value of a “stratigraphy” attribute. Such a method may also include extracting meshed horizon surfaces as iso-values of a stratigraphy function (e.g., stratigraphy property, which is based at least in part on at least one implicit function and at least in part on extracted data).

As an example, the method 810 of FIG. 8 may accommodate global and relatively local changes in dip and/or thickness of geological layers. Such an approach may include computing first a coarse estimate of lateral thickness changes, computing an implicit function in a computational space from which the thickness trends have been removed, and adding back those trends to arrive at a result.

As an example, interpolation of an implicit function may be performed in a computational space from which coarse-scale thickness variations have been removed. In such an example, a method may include removing thickness variation trends in a complex faulted environment optionally without first computing geometry of the faulted layers.

As an example, a method may include mapping input horizons to a set of non-planar surfaces into a computational space that reflects thickness variations and by using this initial mapping to set revised values for an implicit function. In such an example, input points of a given horizon surface may not correspond to the same iso-value of a corresponding calculated implicit function; rather, for individual control points, a constraint value may be computed as a function of thicknesses of layers, for example, located above and below a particular point.

As an example, a method may include calculating implicit function values such that iso-surfaces are substantially parallel to each other (e.g., as in a layer-cake model), even where large variations of dip and/or thickness of layers may exist (e.g., as represented by input data). Such an approach may allow for using second order regularization constraints (e.g., constant or smooth gradient) even in cases where input data geometry is such that it does not support direct minimization of the variation of layer dips and/or thicknesses.

Given the foregoing approach, a consequence may be that the computed implicit function does not represent directly the stratigraphy: horizons may not be expected to correspond to iso-surfaces of the initially computed implicit function.

As mentioned, a method may include converting an implicit function to a “proper” representation of stratigraphy. For example, such converting (e.g., or calculating) may be performed as a post-processing action, for example, after interpolation of an initial implicit function.

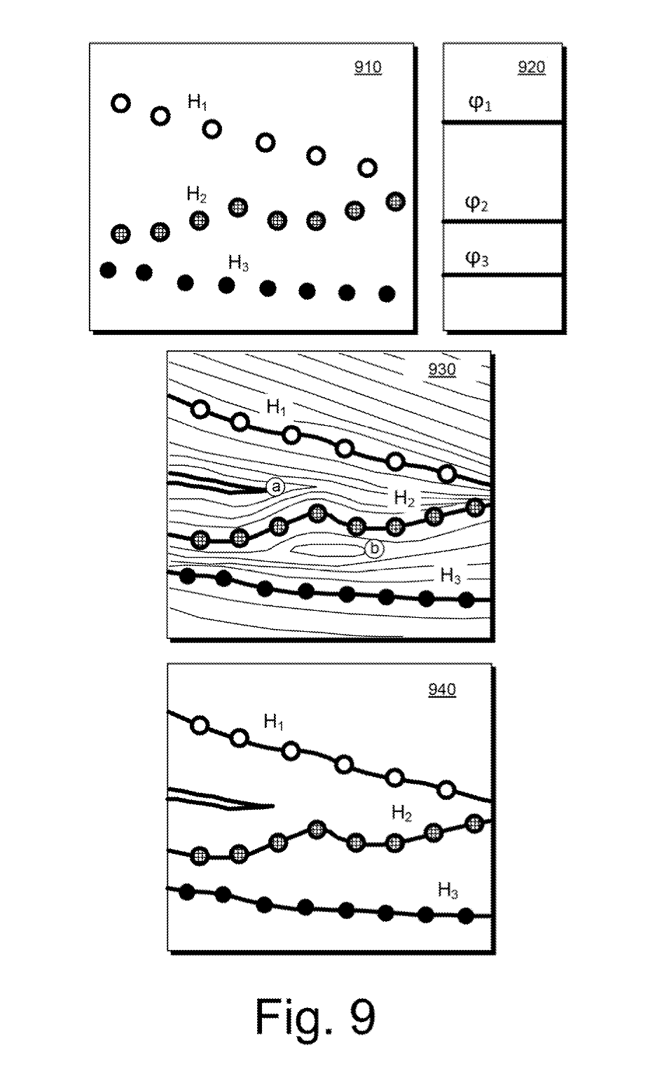

FIG. 9 shows example plots 910, 920, 930 and 940 that graphically illustrate artifacts that may exist when a method such as the method 510 is applied to input data, for example, where spatial trends may exist in dip and/or thickness that may be classified as being “large”.

As shown in FIG. 9, the plot 910 corresponds to input horizon data; the plot 920 corresponds to mapping into the “stratigraphy” computational space, where each horizon is represented by a value of the implicit “stratigraphy” function; the plot 930 corresponds to iso-values of the “stratigraphy” function where artifacts (a) and closed contours (b) do not correspond to real geological features and where (a) and (b) are generated due to contradictory constant gradient and control point constraints; and the plot 940 corresponds to extracted horizons, noting that an extra-piece of horizon was extracted due to numerical artifacts.

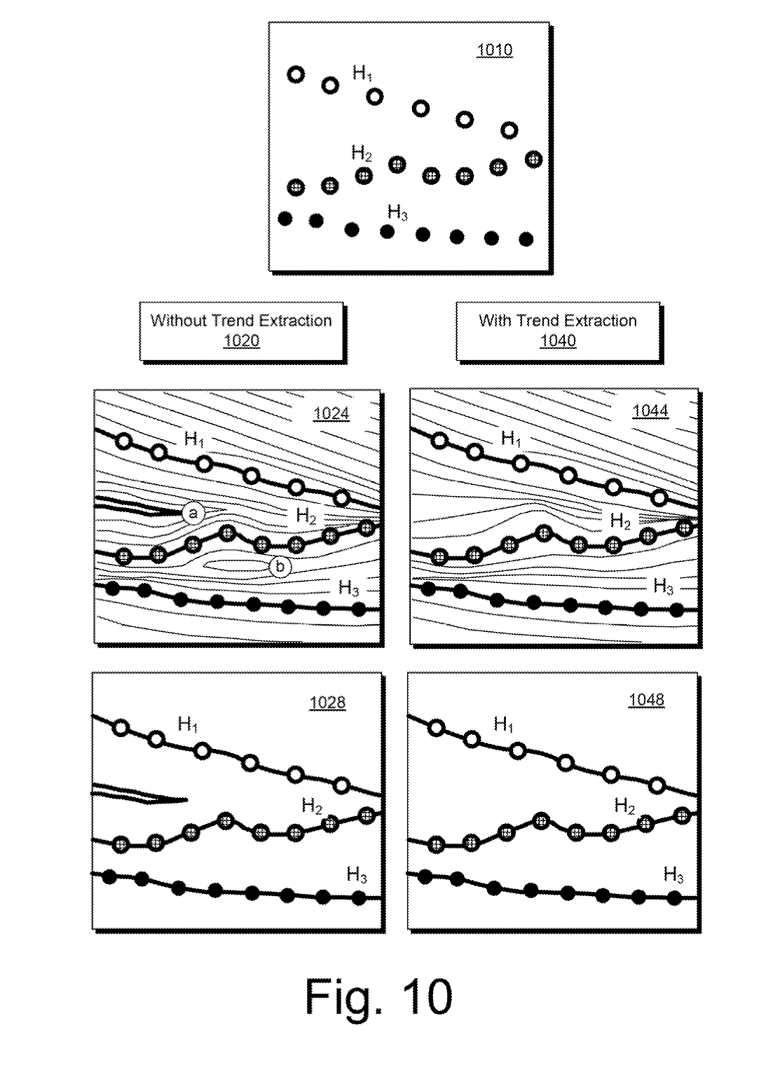

FIG. 10 shows example plots 1010, 1024, 1028, 1044 and 1048 with respect to a method 1020 without trend extraction and with respect to a method 1040 that includes trend extraction. A comparison between the plots 1024 and 1044 and between the plots 1028 and 1048 illustrates how the trend extraction method 1040 acts to reduce artifacts and closed contours such as the artifacts (a) and the closed contours (b) shown in the plots 1028 and 1048.

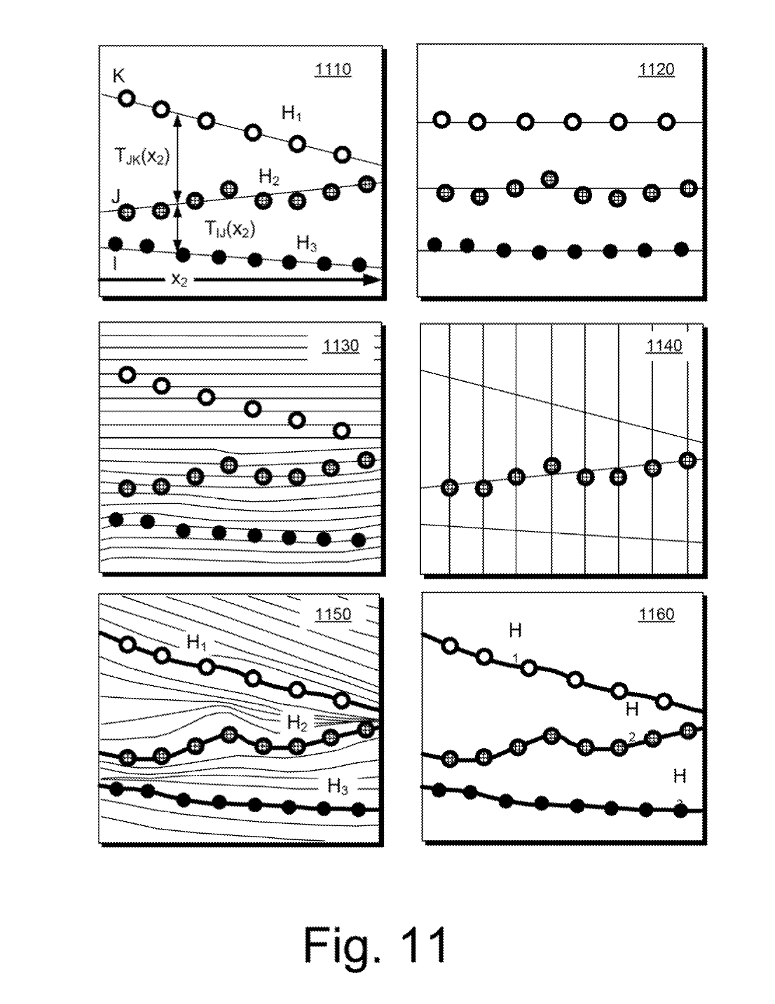

FIG. 11 shows example plots 1110, 1120, 1130, 1140, 1150 and 1160. These plots aim to provide a graphical illustration of a method such as the method 550 of FIG. 5 and the method 810 of FIG. 8. In FIG. 11, the plot 1110 corresponds to large scale thickness variation trends superposed to input data; the plot 1120 corresponds to data embedded into a computational space from which large scale thickness variation trends have been removed, noting that, in practice, such space may not be physically built during a method (e.g., it is included to for the purpose of illustrating a method); the plot 1130 corresponds to iso-values of an implicit function computed after removing thickness variation trends; the plot 1140 corresponds to vertical pillars through the model, for example, used to convert the implicit function to a stratigraphy property; the plot 1150 corresponds to iso-values of stratigraphy property; and the plot 1160 corresponds to extracted horizon surfaces.

As shown in the plot 1110, thickness variation trends may be superposed to input data. As an example, a method may include estimating variations of thicknesses between input horizons. Such estimating may aim to estimate thicknesses that vary smoothly laterally, for example, without estimating across one or more faults that may exist in a region of interest.

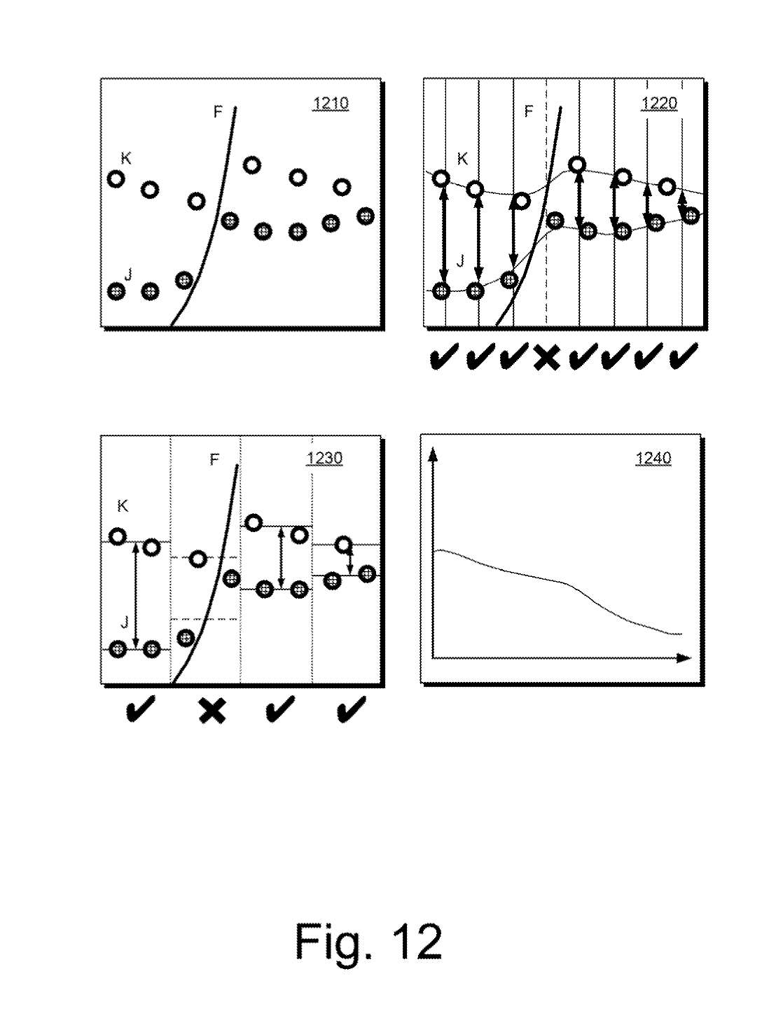

FIG. 12 shows example plots 1210, 1220, 1230 and 1240 that illustrate an approach to estimating thickness, for example, as one or more thickness maps between horizons labeled I and J. For example, the plots 1210, 1220 and 1230 may correspond to a cross-section of a three dimensional model.

In FIG. 12, the plot 1210 corresponds to input data where “F” represents a geological fault (e.g., interpreted based on seismic data, etc.); the plot 1220 corresponds to a technique for estimating thicknesses by computing vertical differences between smooth, unfaulted surfaces where a cross indicates values marked for interpolation; the plot 1230 corresponds to estimating thicknesses by computing vertical differences between clusters of points; and the plot 1240 corresponds to an example of a thickness map obtained for a dataset (see, e.g., the input data of the plot 1210).

As an example, one or more techniques may be implemented to estimate thicknesses. As an example, a technique may include implementation of a 2D gridding algorithm (e.g. convergent gridding, curvature minimization, etc.) to compute smooth, unfaulted surfaces independently from one to another and, for example, sampling of such surfaces (e.g., along regularly spaced vertical pillars, discarding pillars for which one or several fault surface has been sampled in between the considered horizon surfaces). As an example, an isochore map (e.g., vertical thickness map) map may be built, for example, by computing differences in vertical position along remaining pillars and using an interpolation algorithm to fill-in missing values.

As an example, a method may include partitioning input point sets into subsets, for example, according to their lateral (x, y) position, computing average altitude (e.g., or depth) of individual subsets, and estimating thickness of layers by subtracting the altitude of superposed subsets belonging to successive horizons, optionally skipping one or more subsets separated by a fault surface, as appropriate. In such an example, an interpolation algorithm may be implemented to fill-in values (e.g., missing values, etc.).

As an example, one or more computed thickness maps may be post-processed to remove negative values and to smooth an obtained map, for example, by applying a Laplacian smoothing technique.

As an example, a method may include outputting a set of maps covering an area of interest and, for example, representing approximate, smooth thicknesses of layers located between successive (e.g., in a stratigraphic sense) horizons. For example, one map may represent thickness Ti_{→}j between horizons i and j as a function of lateral (x,y) location: Ti_{→}j=f(x, y). In such an example, approximate thickness of a group of layers located between non-successive horizons may be computed by summing (e.g., stacking) thickness maps.

As to setting control point constraints, as an example, consider assigning a value φ(p) to an individual control point constraint (e.g., at a location p) such that the value difference between two points located on the same vertical line and belonging to two different horizons is proportional to an estimated thickness at the vertical location.

As an example, a method may include assigning a value of zero to data points of an arbitrarily selected horizon surface H and assigning to other data points pⱼ(x, y) of another horizon J such that J≠H a value that is linearly proportional to T_{H}_{_{→}}j(x, y) (positive if I is younger depositionally than H, negative otherwise): φ(p_{J}(x,y))=φ_{J}(x,y)=λT_{H}_{_{→}}j(x, y).

As an example, a solution approach that satisfies a property such as that presented above may be employed. For example, an approach may be employed that may not include a correspondence between a horizon and a constant constraint value (e.g., φ).

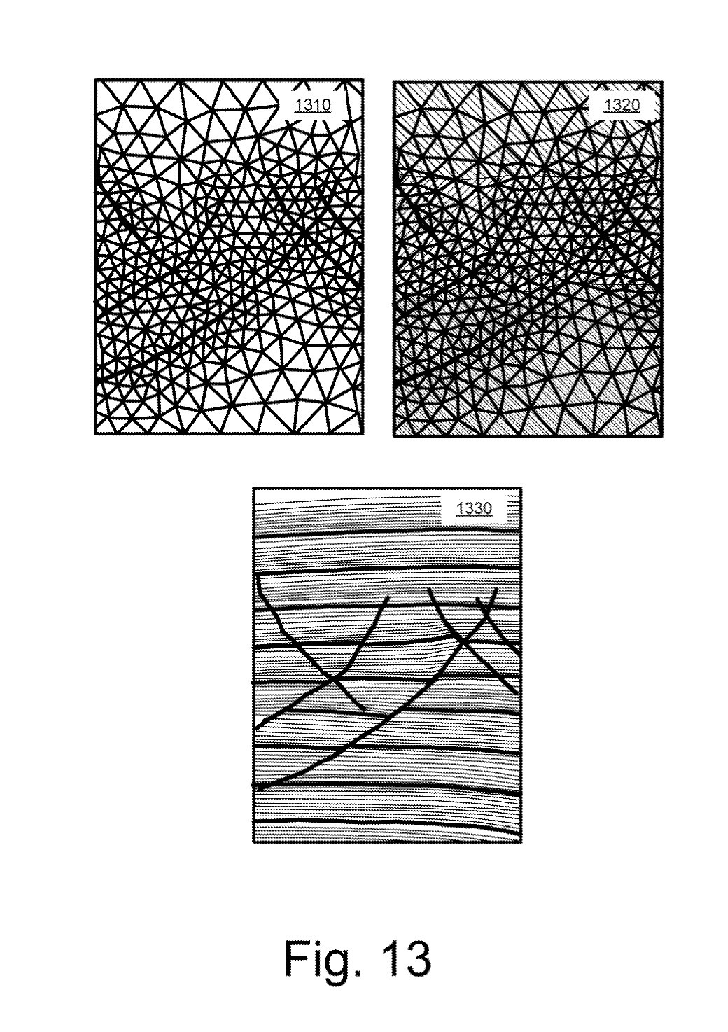

FIG. 13 shows example plots 1310, 1320 and 1330 that illustrate results of an interpolation of an implicit (stratigraphy) function with respect to a 2D model. As shown, the plot 1310 corresponds to values computed at nodes of a background (triangular) mesh, the plot 1320 corresponds to values linearly interpolated on triangle elements, and the plot 1330 corresponds to the property represented using a periodic map (e.g., a periodic color map, etc.).

As an example, once a value φ(p) has been assigned to individual control point constraints, an interpolation of the implicit function may be performed, for example, by solving a linear system of equations that may include at least one constraint on the value and/or gradient of the implicit function and at least one regularization constraint (e.g. smooth gradient, constant gradient and/or harmonic constraint). In such an example, output may include a property φ(α), the value of which may be defined at individual nodes (e.g., where a represents an individual node) of a background mesh. In such an example, interpolation may occur locally within individual elements of the mesh (e.g. by linear interpolation if the mesh elements are simplices; see, e.g., the plot 1310 of FIG. 13). In such an approach, results of the interpolation may not directly represent geological stratigraphy (e.g., it may not be possible to represent horizon surfaces by extracting directly iso-values from the implicit function).

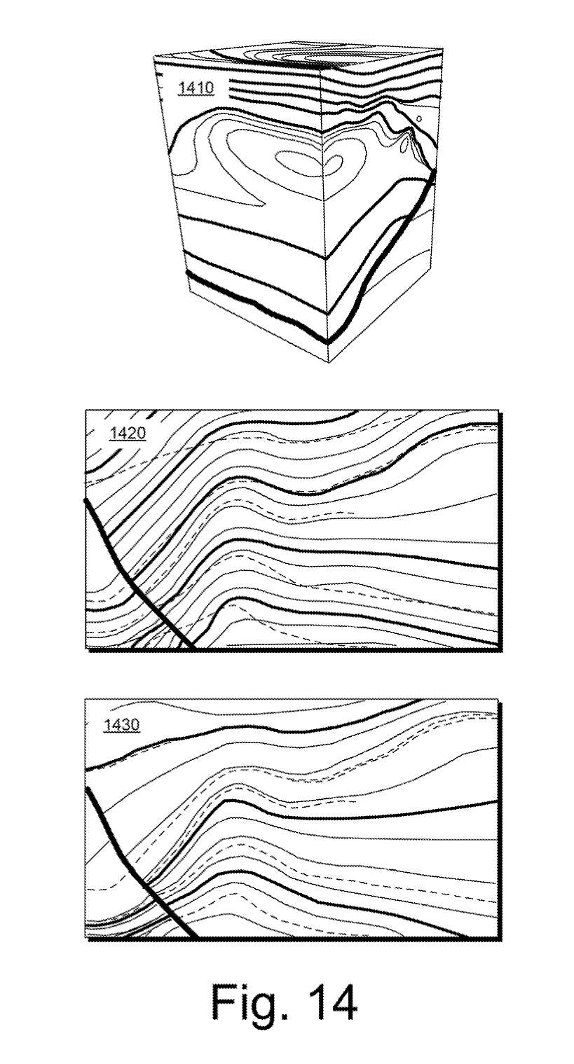

FIG. 14 shows example plots 1410, 1420 and 1430 associated with converting an implicit function to a representation of stratigraphy. As shown in FIG. 14, the plot 1410 corresponds to an implicit “stratigraphy” function calculated using a method such as the method 410 of FIG. 4 or the method 510 of FIG. 5, noting that several artifacts (closed contours) exist in the computed property; the plot 1420 corresponds to an implicit function calculated using a method such as the method 550 of FIG. 5 or the method 810 of FIG. 8, noting that the implicit function does not directly represent stratigraphy (e.g., iso-contours do not necessarily follow input data points); and the plot 1430 corresponds to a stratigraphy function calculated from an implicit function that includes reintroducing previously extracted information, for example, per the method 550 of FIG. 5 or the method 810 of FIG. 8, noting that the plot 1430 indicates freedom from artifacts and iso-contours that properly honor input data points.

As an example, a method may include converting a previously interpolated implicit function φ(α) into a property S(α) that may represent the stratigraphy (see, e.g., the plots 1420 and 1430 of FIG. 14). For example, a conversion process may result in a property S(α) where individual input horizons correspond to an iso-value of the property S(α). In such an example, for individual nodes α of the background mesh, S(α) may be computed as a function g( ) of the implicit function φ(α) and of lateral coordinates (x,y) of individual nodes, for example, represented by the following equation: S(α)=g(φ(α), x, y).

In the foregoing example equation, the function go( ) may be selected such that S(x) may be a constant and, for example, set to an arbitrary value S_{H} for points x that may be located on a common stratigraphic horizon H(S(x)=S_{H}, ∀×⊖H) and, for example, such that S_{J}>S_{I} if horizon J is younger depositionally than horizon I.

As an example, a value φ_{H}(x,y) of an implicit function for an individual input horizon H may be deduced spatially in a region based on a value provided from a thickness map or maps, for example, T_{H}_{_{→}}j(x, y). As an example, a solution technique may include computing a set of monotonously increasing real functions g_{x,y}( ) [symbol] → [symbol] at individual (x,y) locations of individual nodes α(x,y) of a background mesh and, for example, such that g_{x,y}(φ_{H}(x,y))=S_{H} for individual horizons H of a model.

As an example, a method may include defining g_{x,y}( ) as a set of piecewise linear functions satisfying particular conditions. As an example, smoothness of a resulting stratigraphy function may depend on smoothness of one or more g_{x,y}( ) functions. As an example, a method may include using smooth monotonously increasing functions such as, for example, monotone cubic functions. For example, a monotone cubic interpolation may include use of monotone cubic functions that act to preserve monotonicity.

As an example, a method may employ a cubic Hermite spline or cubic Hermite interpolator where individual pieces are third-degree polynomial specified in Hermite form (e.g., via values and first derivatives at end points).

As an example, individual nodes α of a background mesh may be specified with respect to a function such as g_{x,y}( ), which may be a monotone cubic Hermite spline “function” that may be built using pairs (φ_{H}, S_{H}) as control (data) points. In such an example, values for g_{x,y}(φ(α)) may be computed.

As an example, a method may include extracting one or more horizon surfaces (e.g., or other feature surface) using one or more iso-values of a stratigraphy property, which may be a stratigraphy function.

As an example, horizon surfaces (e.g., as used as input; other, intermediate horizons; etc.) may be extracted from a stratigraphy function, for example, by using an iso-surfacing algorithm.

As an example, a method may employ the Circular Incident Edge Lists (CIEL) algorithm, for example, for generating one or more iso-surfaces (e.g., for an unstructured grid or mesh). The CIEL data structure may represent combinatorial information of a mesh, which may make it possible to optimize the classical propagation from local minima paradigm. Per the CIEL algorithm, geometric structures may be replaced by a combinatorial structure and an active edges list may be maintained and iteratively propagated from an iso-surface (e.g., to another iso-surface). As an example, intersected cells of a mesh, incident to each active edge, may be retrieved and intersection polygons generated, for example, by circulating around their facets (e.g., which may enables arbitrary irregular cells to be treated). As the CIEL data structure depends on connections between cells, it is possible to take into account dynamic changes in geometry of a mesh and in property values (e.g., via sorting an extrema list to be updated, etc.).

As an example, a method may be employed for modeling geological layers with large thickness variations, optionally to a region that may include one or more faulted structures. Such a method may be applied, for example, independently from an offset introduced by a fault in geological layers. As an example, such a method may include estimating layer thicknesses in a manner that accounts for one or more faults. As an example, one or more other actions may be implemented without revisions that account for one or more faults. In other words, a method may account for one or more faults in a thickness estimation process where characteristics of such one or more faults may be carried by thickness estimation information (e.g., optionally for reintroduction at a subsequent point in a method).

As an example, a method may be implemented to create, at least in part, a 3D model of a subsurface region, to create a 2D model of a cross-section through a sub-surface region, etc.

As an example, a method may include receiving data for a geologic environment (see, e.g., the block 552 of the method 550); extracting a portion of the data to define extracted data and remaining data (see, e.g., the block 554 of the method 550); formulating a linear system of equations for an implicit function with respect to a mesh that represents the geologic environment (see, e.g., the block 556 of the method 550); solving the linear system of equations subject to at least one constraint and the remaining data for implicit function values (see, e.g., the block 560 of the method 550); calculating stratigraphy property values based at least in part on the extracted data and the implicit function values (see, e.g., the block 562 of the method 550); and, based at least in part on the calculating, outputting the stratigraphy property values with respect to at least a portion of the mesh (see, e.g., the block 564 of the method 550). In such an example, the extracting may include estimating one or more spatial trends, generating one or more thickness maps, etc. As an example, a method may include adjusting a constraint value of at least one constraint to a value deduced by summing thickness maps

As an example, a method may include solving a linear system of equations in a computational space from which at least one trend has been removed (e.g., via extracting a portion of data). In such an example, the method may include calculating stratigraphy property values by adding the at least one trend that has been removed to implicit function values. As an example, implicit function values may be or include scalar field values. As an example, a method may include solving a system of equations for implicit function values where the implicit function values may not represent directly stratigraphy of a geologic environment.

As an example, a method can include calculating stratigraphy property values by formulating a stratigraphy property as a function of an implicit function. For example, a stratigraphy property S(α) may be represented by the equation S(α)=g(φ(α), x, y) where α represents individual nodes of the mesh, where g( ) is a function of an implicit function (φ(α) for individual nodes α of the mesh and where x and y are spatial coordinates for individual nodes α of the mesh.

As an example, one or more computer-readable storage media may include processor-executable instructions to instruct a system to: receive data for a geologic environment; extract a portion of the data to define extracted data and remaining data; formulate a linear system of equations for an implicit function with respect to a mesh that represents the geologic environment; solve the linear system of equations subject to at least one constraint and the remaining data for implicit function values; calculate stratigraphy property values based at least in part on the extracted data and the implicit function values; and output the stratigraphy property values with respect to at least a portion of the mesh.

As an example, a method may include a performance block for performing a simulation of phenomena associated with a geologic environment using at least a portion of a mesh (e.g., or a model based on a mesh or meshes). As to performing a simulation, such a simulation may include interpolating geological rock types, interpolating petrophysical properties, simulating fluid flow, or other calculating (e.g., or a combination of any of the foregoing).

As an example, a system may include instructions to instruct a processor to perform a simulation of a physical phenomenon using at least a portion of a mesh (e.g., or a model based on a mesh or meshes) and, for example, to output results of the simulation to a display.

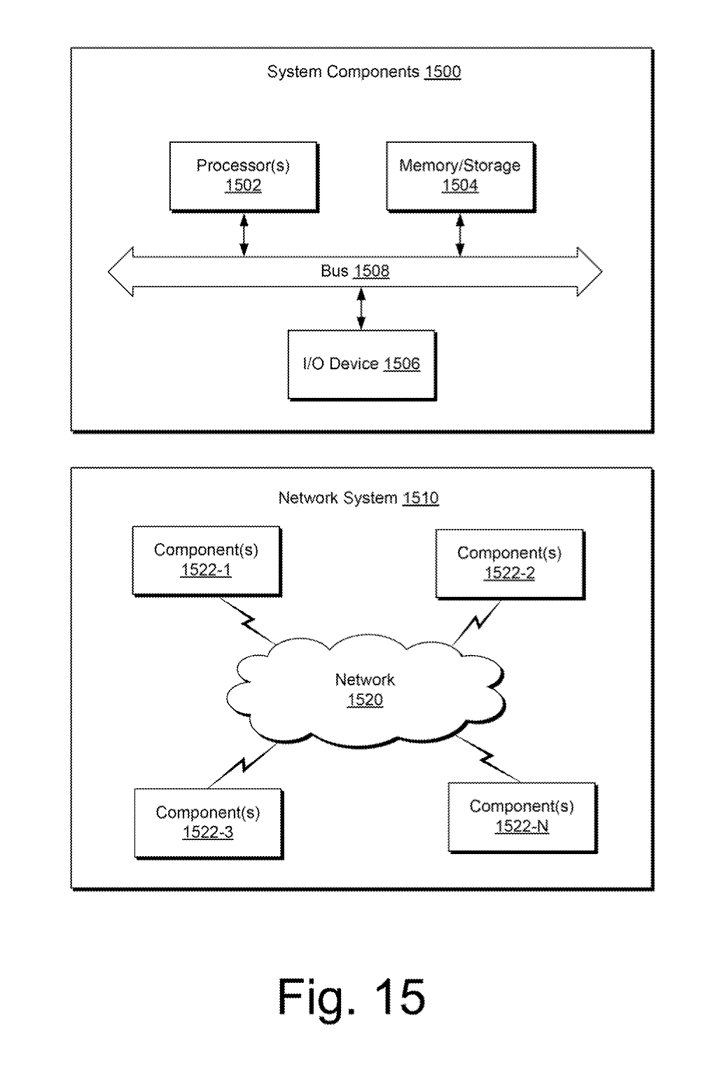

FIG. 15 shows components of an example of a computing system 1500 and an example of a networked system 1510. The system 1500 includes one or more processors 1502, memory and/or storage components 1504, one or more input and/or output devices 1506 and a bus 1508. In an example embodiment, instructions may be stored in one or more computer-readable media (e.g., memory/storage components 1504). Such instructions may be read by one or more processors (e.g., the processor(s) 1502) via a communication bus (e.g., the bus 1508), which may be wired or wireless. The one or more processors may execute such instructions to implement (wholly or in part) one or more attributes (e.g., as part of a method). A user may view output from and interact with a process via an I/O device (e.g., the device 1506). In an example embodiment, a computer-readable medium may be a storage component such as a physical memory storage device, for example, a chip, a chip on a package, a memory card, etc. (e.g., a computer-readable storage medium).

In an example embodiment, components may be distributed, such as in the network system 1510. The network system 1510 includes components 1522-1, 1522-2, 1522-3, . . . 1522-N. For example, the components 1522-1 may include the processor(s) 1502 while the component(s) 1522-3 may include memory accessible by the processor(s) 1502. Further, the component(s) 1502-2 may include an I/O device for display and optionally interaction with a method. The network may be or include the Internet, an intranet, a cellular network, a satellite network, etc.

As an example, a device may be a mobile device that includes one or more network interfaces for communication of information. For example, a mobile device may include a wireless network interface (e.g., operable via IEEE 802.11, ETSI GSM, BLUETOOTH®, satellite, etc.). As an example, a mobile device may include components such as a main processor, memory, a display, display graphics circuitry (e.g., optionally including touch and gesture circuitry), a SIM slot, audio/video circuitry, motion processing circuitry (e.g., accelerometer, gyroscope), wireless LAN circuitry, smart card circuitry, transmitter circuitry, GPS circuitry, and a battery. As an example, a mobile device may be configured as a cell phone, a tablet, etc. As an example, a method may be implemented (e.g., wholly or in part) using a mobile device. As an example, a system may include one or more mobile devices.

As an example, a system may be a distributed environment, for example, a so-called “cloud” environment where various devices, components, etc. interact for purposes of data storage, communications, computing, etc. As an example, a device or a system may include one or more components for communication of information via one or more of the Internet (e.g., where communication occurs via one or more Internet protocols), a cellular network, a satellite network, etc. As an example, a method may be implemented in a distributed environment (e.g., wholly or in part as a cloud-based service).

As an example, information may be input from a display (e.g., consider a touchscreen), output to a display or both. As an example, information may be output to a projector, a laser device, a printer, etc. such that the information may be viewed. As an example, information may be output stereographically or holographically. As to a printer, consider a 2D or a 3D printer. As an example, a 3D printer may include one or more substances that can be output to construct a 3D object. For example, data may be provided to a 3D printer to construct a 3D representation of a subterranean formation. As an example, layers may be constructed in 3D (e.g., horizons, etc.), geobodies constructed in 3D, etc. As an example, holes, fractures, etc., may be constructed in 3D (e.g., as positive structures, as negative structures, etc.).

Although a few example embodiments have been described in detail above, those skilled in the art will readily appreciate that many modifications are possible in the example embodiments. Accordingly, all such modifications are intended to be included within the scope of this disclosure as defined in the following claims. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. It is the express intention of the applicant not to invoke 35 U.S.C. §112, paragraph 6 for any limitations of any of the claims herein, except for those in which the claim expressly uses the words “means for” together with an associated function.

What is claimed is:

1. A method comprising:
receiving data for a geologic environment;
formulating a linear system of equations for an implicit function with respect to a mesh that represents the geologic environment;
solving the linear system of equations as a first sub-system subject to at least one second order smoothness constraint and at least a portion of the data and as a second sub-system subject to at least one first order smoothness constraint and at least a portion of the data; and
based at least in part on the solving, outputting values for the implicit function with respect to at least a portion of the mesh.

2. The method of claim 1 wherein a wavelength parameter determines a first wavelength scale for the first sub-system and a second wavelength scale for the second sub-system wherein the first wavelength scale is greater than the second wavelength scale.

3. The method of claim 2 comprising determining a value for the wavelength parameter based at least in part on dip or variation in thickness of a layer.

4. The method of claim 1 wherein the second sub-system represents a residual of the first sub-system.

5. The method of claim 1 wherein the solving comprises determining values for the implicit function by summing implicit function values associated with the first sub-system and implicit function values associated with the second sub-system.

6. The method of claim 5 wherein the at least one second order smoothness constraint ensures monotonicity of the implicit function values associated with the first sub-system and wherein the solving comprises minimizing the implicit function values associated with the second sub-system to ensure monotonicity of the summed values.

7. The method of claim 1 wherein the minimizing the implicit function values associated with the second sub-system comprises subjecting the second sub-system to a least squares constraint.

8. The method of claim 1 wherein the receiving data for a geologic environment comprises receiving data for a horizon that comprises a dip greater than approximately 10 degrees and wherein the outputting values for the implicit function comprises outputting an iso-value that represents the horizon.

9. One or more computer-readable storage media comprising processor-executable instructions to instruct a system to:
receive data for a geologic environment;
formulate a linear system of equations for an implicit function with respect to a mesh that represents the geologic environment;
solve the linear system of equations as a first sub-system subject to at least one second order smoothness constraint and at least a portion of the data and as a second sub-system subject to at least one first order smoothness constraint and at least a portion of the data; and
based at least in part on a solution, output values for the implicit function with respect to at least a portion of the mesh.

10. A method comprising:
receiving data for a geologic environment;
extracting a portion of the data to define extracted data and remaining data;
formulating a linear system of equations for an implicit function with respect to a mesh that represents the geologic environment;
solving the linear system of equations subject to at least one constraint and the remaining data for implicit function values;
calculating stratigraphy property values based at least in part on the extracted data and the implicit function values; and
based at least in part on the calculating, outputting the stratigraphy property values with respect to at least a portion of the mesh.

11. The method of claim 10 wherein the extracting comprises estimating one or more spatial trends.

12. The method of claim 10 wherein the extracting comprises generating one or more thickness maps.

13. The method of claim 10 comprising adjusting a constraint value of the at least one constraint to a value deduced by summing thickness maps

14. The method of claim 10 wherein the solving comprises solving the linear system of equations in a computational space from which at least one trend has been removed via the extracting the portion of the data.

15. The method of claim 14 wherein the calculating stratigraphy property values comprises adding the at least one trend that has been removed to the implicit function values.

16. The method of claim 10 wherein the implicit function values comprise scalar field values.

17. The method of claim 10 wherein the implicit function values do not represent directly stratigraphy of the geologic environment.

18. The method of claim 10 wherein the calculating stratigraphy property values comprises formulating a stratigraphy property as a function of an implicit function.

19. The method of claim 18 wherein the stratigraphy property S(α) is represented by the equation S(α)=g(φ(α), x, y) wherein α represents individual nodes of the mesh, wherein g( ) is a function of an implicit function φ(α) for individual nodes α of the mesh and wherein x and y are spatial coordinates for individual nodes α of the mesh.

20. One or more computer-readable storage media comprising processor-executable instructions to instruct a system to:
receive data for a geologic environment;
extract a portion of the data to define extracted data and remaining data;
formulate a linear system of equations for an implicit function with respect to a mesh that represents the geologic environment;
solve the linear system of equations subject to at least one constraint and the remaining data for implicit function values;
calculate stratigraphy property values based at least in part on the extracted data and the implicit function values; and
output the stratigraphy property values with respect to at least a portion of the mesh.
